(19) United States
(12) Patent Application Publication
(10) Pub. No.: US 2017/0265459 A1
(43) Pub. Date: Sep. 21, 2017

(54) PROPAGULE COATINGS

(71) Applicant: E I DU PONT DE NEMOURS AND COMPANY, Wilming, DE (US)

(72) Inventors: DOUGLAS ROBERT ANTON, WILMINGTON, DE (US); WAIFONG LIEW ANTON, WILMINGTON, DE (US); OWEN c. COMPTON, WILMINGTON, DE (US); ERIC p. HOLOWKA, HAVERTOWN, PA (US)

(21) Appl. No.: 15/310,343

(22) PCT Filed: Jun. 3, 2015
(86) PCT No.: PCT/US2015/033918

§ 371 Date: Nov. 10, 2016

Related U.S. Application Data
(60) Provisional application No. 62/006,926, filed on Jun. 3, 2014.

(51) Int. Cl. A01N 25/08; A01N 43/56

(52) U.S. Cl. CPC A01N 25/08; A01N 43/56

(57) ABSTRACT

The present disclosure is directed towards a method of coating a propagule with a layer of a coating composition. The coating composition, comprising a film forming binder, a filler, a pesticide and an aqueous carrier, can help to increase the uptake of a pesticide into a resultant plant.

### FIELD OF THE DISCLOSURE

The present disclosure is directed towards a method of coating a propagule with a layer of a propagule coating composition. The propagule coating composition, comprising a film forming binder, a filler, an aqueous carrier, and a pesticide can help to increase the uptake of a pesticide into a resultant plant.

### BACKGROUND OF DISCLOSURE

There are an ever-increasing number of organic compounds, for example, pesticides, being formulated for seed treatment use. Achieving sufficient absorption of such organic compounds into the propagule and/or developing roots to cause effective concentrations in parts of the developing plant for which protection is desired can sometimes be problematical. Although coatings on propagules are exposed to moisture from the propagules and surrounding plant growing medium (e.g., soil), the coating can inhibit the diffusion of water and thus slow the dissolution and/or transport of the organic compound. A common method to increasing the uptake of the pesticide into the developing plant has been to increase the amount of pesticide in the coating composition. This can potentially lead to problems with the higher concentrations of the pesticide being released into the environment and can result in higher priced products.

There is a continuing need for propagule coatings that allow for increased uptake of a pesticide into the growing plant.

### SUMMARY OF THE DISCLOSURE

In a first embodiment, the present disclosure relates to a method comprising the steps of;

i) providing a coating composition, wherein the coating composition comprises:
a) at least one film forming binder,
b) at least one filler; and
c) and aqueous carrier;
   wherein the mean particle size of the filler is in the range of from 5 nanometers to 10 micrometers, the filler concentration is in the range of from 20 to 95 percent by volume, based on the total volume of the dry coating composition, the coating composition has a water permeability of at least 75 milligrams/25 square centimeters/hour, and

ii) adding a pesticide to the coating composition to form a propagule coating composition; wherein the propagule coating composition has a water permeability that is not less than 75 milligrams/25 square centimeters/hour;

iii) applying a layer of the propagule coating composition onto at least a portion of a propagule.

In a second embodiment, the water permeability the coating composition is in the range of from 75 milligrams/25 square centimeters/hour to flux max.

In a third embodiment, the method comprises the steps of;
i) providing a propagule coating composition, wherein the propagule coating composition comprises;
   a) at least one film forming binder,
   b) at least one filler,
   c) an aqueous carrier, and
   d) a pesticide;
ii) applying a layer of the propagule coating composition to at least a portion of a propagule;
   wherein the mean particle size of the filler is in the range of from 5 nanometers to 10 micrometers, the filler concentration of the propagule coating composition that is free from the pesticide is in the range of from 20 percent to 95 percent by volume, based on the volume of the dry pesticide free coating composition, a layer of the pesticide free propagule coating composition has a water permeability of at least 75 milligrams/25 square centimeter/hour, and the propagule coating composition has a water permeability that is not less than 75 milligrams/25 square centimeter/hour.

In a fourth embodiment, the disclosure relates to a method comprising the steps of;
i) providing a propagule coating composition, wherein the propagule coating composition comprises;
   a) at least one film forming binder,
   b) at least one filler,
   c) an aqueous carrier, and
   d) a pesticide;
ii) applying a layer of the propagule coating composition to at least a portion of a propagule;
   wherein the mean particle size of the filler is in the range of from 5 nanometers to 10 micrometers, the filler concentration is in the range of from 20 percent to 95 percent by volume, based on the total volume of the dry comparison coating composition, and the water permeability of the propagule coating composition is not less than 75 milligrams/25 square centimeters/hour; and wherein a comparison coating composition that is identical to the propagule coating composition but for the addition of the pesticide has a water permeability of at least 75 milligrams/25 square centimeters/hour.

In a fifth embodiment, the disclosure relates to a method comprising the steps of;
i) providing a propagule coating composition, wherein the propagule coating composition comprises;
   a) at least one film forming binder,
   b) at least one filler,
   c) an aqueous carrier, and
   d) a pesticide,
ii) applying a layer of the propagule coating composition to at least a portion of a propagule;
   wherein the mean particle size of the filler is in the range of from 5 nanometers to 10 micrometers, the filler concentration is in the range of from 20 percent to 95 percent by volume, based on the total volume of the dry comparison coating composition, and wherein a comparison coating composition that is identical to the propagule coating composition but for the addition of the pesticide has a water permeability of at least 75 milligrams/25 square centimeters/hour, and the addition of the pesticide to the comparison coating composition does not decrease the water permeability to less than 75 milligrams/25 square centimeters/hour.

In a sixth embodiment, the disclosure relates to a propagule coating composition comprising coating composition and a pesticide, wherein the coating composition comprises;
a) at least one film forming binder,
b) at least one filler, and
c) an aqueous carrier,
   wherein the mean particle size of the filler is in the range of from 5 nanometers to 10 micrometers, the filler concentration of the coating composition is in the range of from 20 percent to 95 percent by volume, based on the total volume of the dry coating composition, the coating composition has a water permeability of at least 75 milligrams/25 square centimeters/hour; and wherein the propagule coating composition has a water permeability that is not less than 75 milligrams/25 square centimeters/hour, and wherein the propagule coating composition is applied to a propagule.

In a seventh embodiment, the disclosure relates to a propagule coating composition comprising coating composition and a pesticide, wherein the coating composition comprises;
d) at least one film forming binder,
e) at least one filler, and
f) an aqueous carrier,
   wherein the mean particle size of the filler is in the range of from 5 nanometers to 10 micrometers, the filler concentration of the coating composition is in the range of from 20 percent to 95 percent by volume, based on the total volume of the dry coating composition, the coating composition has a water permeability of at least 75 milligrams/25 square centimeters/hour; and wherein the propagule coating composition has a water permeability that is not less than 75 milligrams/25 square centimeters/hour.

In an eighth embodiment, the disclosure relates to a propagule coated with a layer of the propagule coating composition as described above.

In a ninth embodiment, the disclosure relates to a kit comprising a first component and a second component, wherein the first component comprises a coating composition wherein the coating composition comprises:
a) at least one film forming binder,
b) at least one filler, and
c) an aqueous carrier,
   wherein the mean particle size of the filler is in the range of from 5 nanometers to 10 micrometers, the filler concentration is in the range of from 20 to 95 percent by volume, based on the total volume of the dry coating composition and the coating composition has a water permeability of at least 75 milligrams/25 square centimeters/hour, and the second component comprises a pesticide.

In a tenth embodiment, the disclosure relates to a method comprising the steps of;
i) providing a coating composition wherein the coating composition comprises;
   a) at least one film forming binder,
   b) at least one filler, and
   c) an aqueous carrier;
wherein the reduced filler volume concentration of the coating composition is in the range of from 80 percent to 150 percent, the mean particle size of the filler is in the range of from 5 nanometers to 10 micrometers, and the coating composition has a water permeability of at least 75 milligrams/25 square centimeters/hour;
ii) adding a pesticide to the coating composition to form a propagule coating composition, wherein the propagule coating has a water permeability that is not less than 75 milligrams/25 square centimeters/hour; and
iii) applying a layer of the propagule coating composition onto at least a portion of a propagule.

The present disclosure also relates to a number of other embodiments, such as those described below.

In any one of the above methods, the method can further comprise the step of removing at least a portion of the aqueous carrier, wherein the water removal step is performed after the application of a layer of the propagule coating composition onto at least a portion of the propagule.

In any one of the above methods, the method may further comprise the step of placing the coated propagule in a growing media.

In any of the above embodiments, the water permeability of the coating composition is in the range of from 75 milligrams/25 square centimeters/hour to flux max.

In any of the above embodiments, the water permeability of the propagule coating composition is in the range of from 75 milligrams/25 square centimeters/hour to flux max.

In any one of the above embodiments, the water permeability of the coating composition is at least 85 milligrams/25 square centimeters/hour.

In any one of the above embodiments, the water permeability of the coating composition is at least 90 milligrams/25 square centimeters/hour.

In any one of the above embodiments, the water permeability of the coating composition is at least 100 milligrams/25 square centimeters/hour.

In any one of the above embodiments, the at least one filler is substantially spherical and has a water solubility at 20° C. of less than 100 milligrams per liter of water.

In any one of the above embodiments, the at least one filler is silica, colloidal silica, fumed silica, silica gel, iron oxide, calcium carbonate, calcium sulfate, magnesium carbonate, barium carbonate, barium sulfate, zinc oxide, talc, kaolin, titanium dioxide, lithopone, aluminum oxide, illite, smectite, montmorillonite, quartz, pumice, zeolites, diatomaceous earth, perlite, dolomite, alumina modified colloidal silica, alumina modified fumed silica or a combination thereof.

In any one of the above embodiments, the at least one film forming binder is a water soluble or water dispersible film forming binder.

In any one of the above embodiments, the at least one film forming binder is polyvinyl pyrrolidone, ethylene vinyl acetate, polyvinyl acetate, polyvinyl acetate copolymer, hydrolyzed polyvinyl acetate, partially hydrolyzed polyvinyl acetate, polyvinylpyrrolidone-vinyl acetate copolymer, polyvinyl alcohol, polyvinyl alcohol copolymer, polyvinyl methyl ether, polyvinyl methyl ether-maleic anhydride copolymer, polyethylene glycol, polyethylene glycol copolymers, polytrimethylene ether glycol, polytrimethylene ether glycol copolymers, waxes, latex polymer, polyurethane, ethylcellulose, methylcellulose, carboxymethyl cellulose, hydroxymethylcellulose, hydroxypropylcellulose, hydroxymethylpropylcellulose, hydroxylpropyl cellulose polyvinylpyrrolidone, alginate, dextrin, malto-dextrin, polysaccharide, fats, oils, protein, karaya gum, guar gum, tragacanth gum, polysaccharide gum, mucilage, gum arabic, shellac, vinylidene chloride polymer, vinyl chloride copolymer, soybean protein-based polymer, soybean protein-based copolymers, lignosulfonate, acrylic copolymer, starch, zein, gelatin, polyacrylate, polystyrene, polystyrene acrylic copolymer, styrene butadiene copolymer, poly(N-vinylacetamide chitosan), polyethylene glycol, polytrimethylene glycol, acrylamide polymers, acrylamide copolymer, polyhydroxyethyl acrylate, casein, gelatin, sodium alginate, pullulan, polymethylacrylamide, alginate, polychloroprene or a combination thereof.

In any one of the above embodiments, the at least one film forming binder is polyvinyl pyrrolidone, ethylene vinyl acetate, polyvinyl acetate, polyvinyl acetate copolymer, hydrolyzed polyvinyl acetate, partially hydrolyzed polyvinyl acetate, polyvinylpyrrolidone-vinyl acetate copolymer, polyvinyl alcohol, polyvinyl alcohol copolymer or a combination thereof.

In any one of the above embodiments, the at least one pesticide comprises an anthranilic diamide of Formula 1, N-oxides, or salts thereof;

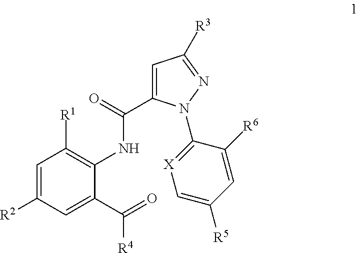

wherein
X is N, CF, CCl, CBr or Cl;
R¹ is CH₃, Cl, Br or F;
R² is H, F, Cl, Br or —CN;
R³ is F, Cl, Br, C1 to C4 haloalkyl, C1 to C4 haloalkoxy or Q;
R⁴ is NR⁷R⁸, N═S(CH₃)₂, N═S(CH₂CH₃)₂, N═S(CH(CH₃)₂)₂;
R⁵ is H, F, Cl or Br;
R⁶ is H, F, Cl or Br;
each R⁷ and R⁸ is independently H, C1 to C6 alkyl, C3 to C6 cycloalkyl, cyclopropylmethyl or 1-cyclopropylethyl; and
Q is a —CH₂-tetrazole radical.

In any one of the above embodiments, the pesticide comprises an anthranilic diamide of Formula 2, N-oxides, or salts thereof;

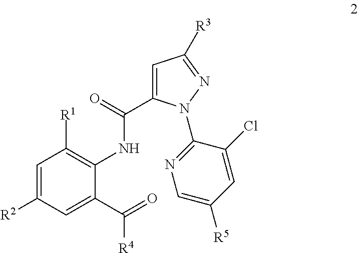

wherein
R¹ is CH₃, Cl, Br or F;
R² is H, F, Cl, Br or —CN;
R³ is F, Cl, Br, C1 to C4 haloalkyl, C1 to C4 haloalkoxy or Q;
R⁴ is NHCH₃, NHCH₂CH₃, NHCH(CH₃)₂, NHC(CH₃)₃, NHCH₂(cyclopropyl), NHCH (cyclopropyl)CH₃, N═S(CH₃)₂, N═S(CH₂CH₃)₂, N═S(CH(CH₃)₂)₂, or 1-cyclopropylethyl;
R⁵ is H, F, Cl or Br.

In any one of the above embodiments, Q is a structure according to any one of Q-1 through Q-11;

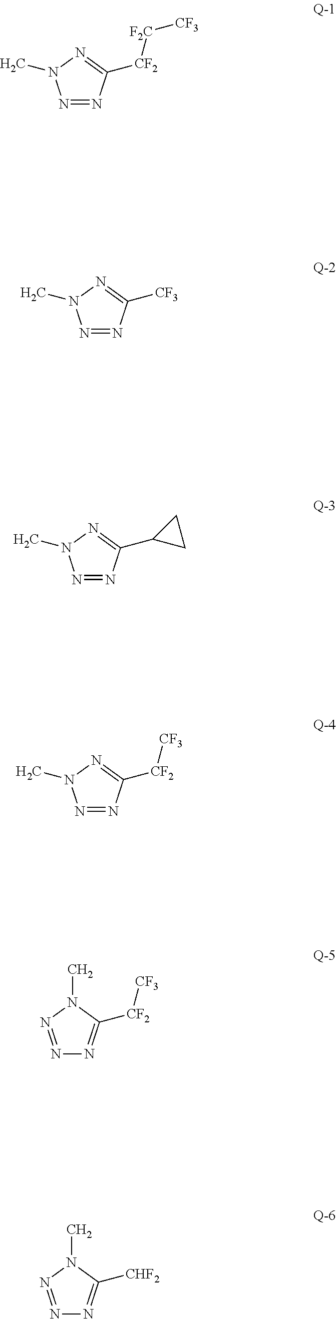

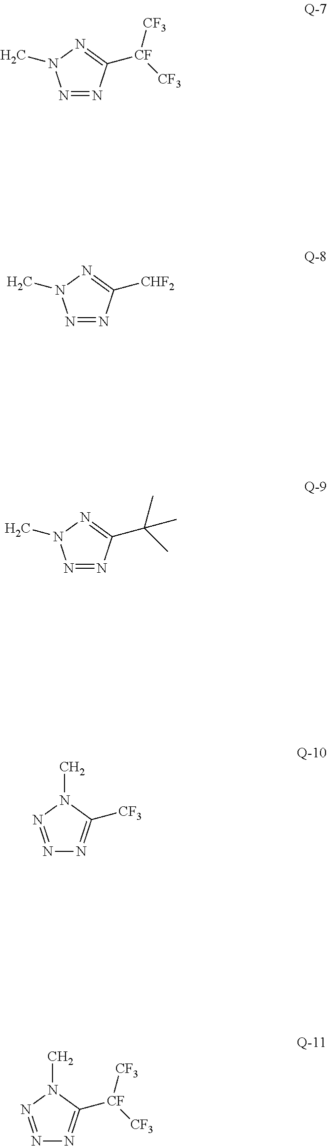

In any one of the above embodiments, the anthranilic diamide or N-oxides, or salts thereof can have any one of the formulae listed in TABLE I-1, shown below.

In any one of the above embodiments, a plant grown from the coated propagule exhibits an increased uptake of the pesticide when compared to a second plant grown from a propagule coated with a second coating composition that is identical to the first coating composition but for the water permeability of the second coating composition, which, in the second coating composition has a water permeability of less than 75 milligrams/25 square centimeters/hour.

In any one of the above embodiments, the pesticide is chlorantraniliprole or cyantraniliprole.

In any one of the above embodiments, wherein the filler concentration is greater than or equal to 40 percent by volume.

In any one of the above embodiments, wherein the water solubility at 20° C. of the pesticide is in the range of from 0.001 milligrams per liter to 100 milligrams per liter.

In any one of the above embodiments, the water solubility at 20° C. of the pesticide is in the range of from 0.001 milligrams per liter to 50 milligrams per liter.

In any one of the above embodiments, the filler concentration is in the range of from 40 percent to 95 percent by volume.

In any one of the above embodiments, the propagule coating composition can have a reduced filler volume concentration that is in the range of from 80 percent to 150 percent.

In any one of the above embodiments, the propagule coating composition can have a reduced filler volume concentration that is greater than 90 percent.

### DETAILED DESCRIPTION

The features and advantages of the present disclosure will be more readily understood, by those of ordinary skill in the art from reading the following detailed description. It is to be appreciated that certain features of the disclosure, which are, for clarity, described above and below in the context of separate embodiments, may also be provided in combination in a single element. Conversely, various features of the disclosure that are, for brevity, described in the context of a single embodiment, may also be provided separately or in any sub-combination. In addition, references to the singular may also include the plural (for example, “a” and “an” may refer to one or more) unless the context specifically states otherwise.

The use of numerical values in the various ranges specified in this application, unless expressly indicated otherwise, are stated as approximations as though the minimum and maximum values within the stated ranges were both proceeded by the word “about”. In this manner, slight variations above and below the stated ranges can be used to achieve substantially the same results as values within the ranges. Also, the disclosure of these ranges is intended as a continuous range including the minimum and maximum values of the range and each and every value between the minimum and maximum values.

As used herein:

As used herein the phrase “biologically effective amount” refers to that amount of a substance required to produce a desired effect on a plant, on an insect, or a plant pest. Effective amounts of the substance will depend on several factors, including the treatment method, plant species, pest species, propagating material type and environmental conditions. For example, a biologically effective amount of an insecticide would be the amount of the insecticide that protects a plant from damage. This does not mean that protected plant suffers no damage from the pest, but that the damage is at such a level as to allow the plant to give an acceptable yield of a crop.

The term “pesticide” refers to any chemical classified as a pesticide or active ingredient (a.i.) by any regulatory authority; for example in the United States by the Environmental Protection Agency (EPA). Generally, a pesticide is a chemical which, when applied in a pesticidally sufficient amount to a susceptible plant, animal and/or microorganism and/or to the locus thereof, kills, inhibits or alters the growth of the plant, animal and/or microorganism.

As used herein, the term “propagule” means a seed or a regenerable plant part. The term “regenerable plant part” means a part of a plant other than a seed from which a whole plant may be grown or regenerated when the plant part is placed in horticultural or agricultural growing media such as, for example, moistened soil, peat moss, sand, vermiculite, perlite, rock wool, fiberglass, coconut husk fiber, tree fern fiber, or a completely liquid medium such as water. The term “geotropic propagule” means a seed or a regenerable plant part obtained from the portion of a plant ordinarily disposed below the surface of the growing medium. Geotropic regenerable plant parts include viable divisions of rhizomes, tubers, bulbs and corms which retain meristematic tissue, such as an eye. Regenerable plant parts such as cut or separated stems and leaves derived from the foliage of a plant are not geotropic and thus are not considered geotropic propagules. As referred to in the present disclosure and claims, unless otherwise indicated, the term “seed” specifically refers to an unsprouted seed or seeds. The term “foliage” refers to parts of a plant exposed above ground. Therefore foliage includes leaves, stems, branches, flowers, fruits and/or buds. The phrase “resultant plant” refers to a plant that has been grown or regenerated from a propagule that has been placed in growing media.

The term “rhizosphere” as defined herein refers to the area of soil that is directly influenced by plant roots and microorganisms in the soil surrounding the roots. The area of soil surrounding the roots is generally considered to be about 1 millimeter wide but has no distinct edge.

As used herein, the phrase “water permeability of the coating composition” means the amount of water transmitted through a layer of a coating composition over a given time period. The water permeability of the coating composition can be measured by a variety of methods. In the present disclosure and claims, the water permeability is measured using a variant of ASTM D1653-03, described below. With respect to the present invention when a coating composition is described as having a water permeability of a numerical value, it is intended that the numeric value is that obtained by the procedure described immediately following this paragraph.

The water permeability of a coating composition is determined using a variant of ASTM D1653-03 water flux method and requires a high humidity environment. The high humidity environment is provided by a Caron 6010 Environment chamber (available from Caron Products and Services, Inc., Marietta, Ohio) with the temperature set to 35° C. and the humidity set to 70 percent relative humidity (RH).

A layer of a coating composition is drawn down onto Leneta chart paper (Leneta Form NWK, Unsealed Test Chart, available from the Leneta Company, Mahwah, N.J.) using a #90 wire wound rod (Gardner Co. STD 16″OA, ½″ diameter #90 rod). The applied layer of coating composition on the Leneta chart paper is allowed to dry overnight in an oven set to a temperature of 30° C. with slight nitrogen purge. The dry film thicknesses are typically between 38 and 64 micrometers.

Water permeability is measured using 25 square centimeter (cm²) Perm cups available from Paul Gardner Company, Pompano Beach, Fla. The cups are charged with 10 grams of DRIERITE© desiccant (available from the W.A. Hammond Drierite Co. Ltd., Xenia, Ohio) and a disc of the coating on the Leneta chart paper is mounted on top. The cup is weighed and then put into the Caron 6010 Environment chamber with the temperature set to 35° C. and 70 percent relative humidity. The cup is removed for weighing every hour. The weight gain is plotted as a function of time and the slope of the line gives the water permeability of the film, in units of milligrams/25 square centimeters/hour (mg/25 cm²/hr). Using this procedure, the flux seen with the Leneta chart paper alone in any given experimental run (without any of the coating composition applied) is about 117 to about 154 mg/25 cm²/hr. The water permeability observed when the coating composition is applied to the chart paper substrate (when measured according to the method described specifically above) cannot exceed the water permeability observed with the chart paper alone. Therefore, the maximum water flux measurable by this variant of ASTM 1653-03 is about 154 mg/25 cm²/hr. It is possible that the actual water permeability of an applied layer of the coating composition in absolute terms or using a different experimental method is higher than the water permeability that can be measured using the disclosed variant of ASTM 1653-03. Other variations, for example, using a paper substrate that has a water permeability greater than the Leneta chart paper, may produce a higher water permeability.

The phrase “flux max” as used herein means the maximum water permeability measurable when using the paper alone without the coating composition or without the propagule coating composition. In this way, if the particular chart paper described above is not available, the maximum water permeability can be determined using a suitable replacement paper, which may be greater than the about 154 milligrams/25 square centimeters/hour referenced above when using the Leneta Form NWK, Unsealed Test Chart.

As used herein, the phrase “filler concentration” means the volume percentage of the discontinuous phase or phases of filler in a volume of the coating composition divided by the total volume of the continuous binder and discontinuous filler phases of the dry coating composition. It should be understood that the filler concentration of the coating composition is determined after the aqueous carrier has been removed and before the addition of the pesticide.

As used herein, the phrase “critical filler volume concentration” (or cFVC) refers to the filler concentration where just sufficient film forming binder (i.e., the continuous phase) is present to fill the voids between the filler particles of the dry coating composition.

As used herein, the phrase “reduced filler volume concentration” or “reduced FVC” is defined as the actual filler volume concentration (FVC) of the coating composition divided by the critical filler volume concentration (critical FVC or cFVC). For each filler and film forming binder system, the cFVC can be different and must be determined experimentally.

The phrase “particle size” refers to the equivalent spherical diameter of a filler particle, i.e., the diameter of a sphere enclosing the same volume as the particle. “Mean particle size” is the numerical value at which 50 percent of the mass of the particles have particle sizes which are less than or equal to the numerical value. With reference to particle size distribution, percentages of particles are also on a volume basis (for example, “at least 95 percent of the particles are less than about 10 microns” means that at least 95 percent of the aggregate volume of particles consists of particles having equivalent spherical diameters of less than about 10 microns). The principles of particle size analysis are well-known to those skilled in the art; for a technical paper providing a summary, see A. Rawle, “Basic Principles of Particle Size Analysis” (document MRK034 published by Malvern Instruments Ltd., Malvern, Worcestershire, UK). Volume distributions of particles in powders can be conveniently measured by such techniques as Low Angle Laser Light Scattering (also known as LALLS and Laser Diffraction), which relies on the fact that diffraction angle is inversely proportional to particle size. Further, the particle sizes, as referred to in the description and in the claims, are the particle sizes before the particles are incorporated into the coating composition.

The phrase “C1 to C6 alkyl” means a straight chain or branched alkyl group having in the range of from 1 to 6 carbon atoms, for example, methyl, ethyl, n-propyl, i-propyl, or the various butyl, pentyl or hexyl isomers.

The phrase “C3 to C6 cycloalkyl” include, for example, cyclopropyl, cyclobutyl, cyclopentyl or cyclohexyl isomers.

The phrase “C1 to C4 haloalkyl” means an alkyl group having in the range of from 1 to 4 carbon atoms and substituted by one or more halogen atoms, which includes fluorine, chlorine, bromine or iodine. The alkyl group may be partially or fully substituted with halogen atoms which may be the same or different.

The phrase “C1 to C4 haloalkoxy” means an alkoxy group having in the range of from 1 to 4 carbon atoms, for example methoxy, ethoxy, n-propoxy, i-propoxy, and the various butoxy isomers, and further substituted by one or more halogen atoms, which includes fluorine, chlorine, bromine or iodine. The alkoxy group may be partially or fully substituted with halogen atoms which may be the same or different. Suitable examples can include, for example, CF₃O—, CCl₃CH₂O—, HCF₂CH₂CH₂O— and CF₃CH₂O—.

As used herein, the term “systemic” refers to the active ingredient of a pesticide that can be absorbed by the roots or foliage of a plant and translocated to other plant tissues.

The current disclosure is related to a method comprising the step of;

i) providing a coating composition wherein the coating composition comprises;
a) at least one film forming binder,
b) at least one filler;
c) an aqueous carrier,
   wherein the mean particle size of the filler is in the range of from 5 nanometers to 10 micrometers, the filler concentration is in the range of from 20 to 95 percent by volume, based on the total volume of the dry coating composition, and a layer of the coating composition has a water permeability of at least 75 milligrams/25 square centimeter/hour, and

ii) adding a pesticide to the coating composition to form a propagule coating composition, wherein a layer of the propagule coating composition has a water permeability that is not less than 75 milligrams/25 square centimeters/hour; and

iii) applying a layer of a coating composition onto at least a portion of a propagule.

It has been found that a propagule having at least a portion of its surface coated according to the disclosed method can exhibit, in the resultant plant, an increased uptake of the pesticide. As used herein, “increased uptake” means that a resultant plant, that is, a plant grown from a propagule coated according to the disclosed method, has a larger amount of the pesticide distributed within its leaves, stems, shoots and/or roots when compared to a plant grown from a propagule coated with a layer of a comparison coating composition, which in the comparison coating composition has the same amount of the pesticide per seed as the disclosed coating composition but, has a water permeability of less than 75 milligrams/25 square centimeters/hour, that is, a lower filler concentration. In some embodiments, the amount of pesticide distributed within the leaves, stems, shoots and/or roots of a plant grown from a propagule coated with a layer of the disclosed propagule coating composition will be greater than or equal to that of a plant grown from a propagule coated with a comparison coating with a water permeability of less than 75 milligrams/25 square centimeters/hour even though the amount of pesticide per seed in the propagule coated a layer of the disclosed coating composition is significantly less than the amount of pesticide per seed in the propagule coated with a less water permeable comparison coating composition.

The step of applying a layer of the propagule coating composition onto at least a portion of the propagule can be accomplished according to any of the known methods, for example, drum coating, fluidized bed coating, curtain coating, spray coating, flow coating and bowl coating techniques. In some embodiments, the layer of the propagule coating composition covers greater than or equal to 50 percent of the surface of the propagule, and in other embodiments, the layer of the propagule coating composition covers greater than or equal to 75 percent of the surface of the propagule. In other embodiments, substantially the entire surface, that is, greater than or equal to 95 percent, of the surface of the propagule is coated with a layer of the propagule coating composition. In other embodiments the entire surface of the propagule is coated with a layer of the propagule coating composition

In one method, propagules are coated by spraying the propagule coating composition comprising directly into a tumbling bed of seeds and then drying the propagules. In one embodiment for coating seeds, the propagule and the propagule coating composition are mixed in a conventional seed coating apparatus. The rate of rolling and application of the layer of propagule coating composition depends upon the seed. For large oblong seeds such as, for example, cotton, a satisfactory coating apparatus comprises a rotating type pan with lifting vanes turned at sufficient rpm to maintain a rolling action of the seed, facilitating uniform coverage. The layer of propagule coating composition must be applied over sufficient time to allow drying to minimize clumping of the seed. Using forced air or heated forced air can allow increasing the rate of application. One skilled in the art will also recognize that this process may be a batch or continuous process. As the name implies, a continuous process allows the seeds to flow continuously throughout the product run. New seeds enter the pan in a steady stream to replace coated seeds exiting the pan.

In further embodiments, the disclosed method can further comprise the step of; iii) removing at least a portion of the aqueous carrier from the applied layer of propagule coating composition. The step of removing at least a portion of the aqueous carrier from the applied layer of propagule coating composition can be accomplished by any of the techniques known in the art. For example, exposing the coated propagule to a low humidity environment, heating the coated propagule, directing a forced stream of air, inert gas or nitrogen over the coated propagule, exposing the coated propagule to less than atmospheric pressure or a combination thereof. If the coated propagule is heated to remove at least a portion of the aqueous carrier, the elevated temperature must not be so high as to damage the propagule itself.

In still further embodiments, the method can further comprise the step of; iv) placing the coated propagule in an horticultural or agricultural growing medium. This step is generally accomplished by the end-user of the coated propagule, for example, the farmer or the grower.

The coating composition comprises a) at least one film forming binder, b) at least one filler and c) an aqueous carrier. The film forming binder can be present in the coating composition in the range of from 2 percent by volume to about 80 percent by volume based on the total volume of the dry coating resulting from the removal of the aqueous carrier from the coating composition. In other embodiments, the film forming binder can be present in the range of from 2 percent by volume to 50 percent by volume. In still further embodiments the film forming binder can be present in the range of from 2 percent by volume to 25 percent by volume. Suitable film forming binders are polymers that are water soluble or water dispersible. By water soluble is meant that the film forming binder has a water solubility at 20° C. of greater than or equal to about 10 grams per liter. Water dispersible polymers are those polymers that form a 2-phase system wherein the polymer is distributed as dispersed particles throughout the continuous aqueous carrier.

Suitable film forming binders can include, for example, polyvinyl pyrrolidone, ethylene vinyl acetate, polyvinyl acetate, polyvinyl acetate copolymer, hydrolyzed polyvinyl acetate, partially hydrolyzed polyvinyl acetate, polyvinylpyrrolidone-vinyl acetate copolymer, polyvinyl alcohol, polyvinyl alcohol copolymer, polyvinyl methyl ether, polyvinyl methyl ether-maleic anhydride copolymer, polyethylene glycol, polyethylene glycol copolymers, polytrimethylene ether glycol, polytrimethylene ether glycol copolymers, waxes, latex polymer, polyurethane, ethylcellulose, methylcellulose, carboxymethyl cellulose, hydroxymethylcellulose, hydroxypropylcellulose, hydroxymethylpropylcellulose, hydroxylpropyl cellulose polyvinylpyrrolidone, alginate, dextrin, malto-dextrin, polysaccharide, fats, oils, protein, karaya gum, guar gum, tragacanth gum, polysaccharide gum, mucilage, gum arabic, shellac, vinylidene chloride polymer, vinyl chloride copolymer, soybean protein-based polymer, soybean protein-based copolymers, lignosulfonate, acrylic copolymer, starch, zein, gelatin, polyacrylate, polystyrene, polystyrene acrylic copolymer, styrene butadiene copolymer, poly(N-vinylacetamide chitosan), polyethylene glycol, polytrimethylene glycol, acrylamide polymers, acrylamide copolymer, polyhydroxyethyl acrylate, casein, gelatin, sodium alginate, pullulan, polymethylacrylamide, alginate, polychloroprene or a combination thereof. In some embodiments, the film forming binder can be polyvinyl alcohol, polyvinylpyrrolidinone-vinyl acetate copolymer, hydrolyzed polyvinyl acetate, partially hydrolyzed polyvinyl acetate, or a combination thereof.

Suitable film forming binders can have a number average molecular weight in the range of from 1,000 to 500,000. In other embodiments, the number average molecular weight can be in the range of from 1,000 to 100,000 or, in still further embodiments, in the range of from 1,000 to 50,000.

Latex polymers may also be used as the film forming binder. The term “latex” is defined as being a stable dispersion of a polymer in an aqueous carrier. The latex polymers typically have number average molecular weights in the range of from 500,000 to 10,000,000. In other embodiments, the latex polymer can have a number average molecular weight in the range of from 600,000 to 5,000,000 and, in still further embodiments, the number average molecular weight can be in the range of from 750,000 to 2,000,000. Latex polymers are well known in the art and can be, for example, vinyl acetate latexes, ethylene vinyl acetate latexes, acrylic latexes, styrene-butadiene latexes, polyester latexes, polyurethane latexes or a combination thereof.

The coating composition also comprises at least one filler, wherein the mean particle size of the filler is in the range of from 5 nanometers to about 10 micrometers. In other embodiments, the mean particle size of the filler can be in the range of from 5 nanometers to about 3 micrometers. In other embodiments, the mean particle size of the fillers can be in the range of from 10 nanometers to about 2 micrometers, and, in still further embodiments, can be in the range of from 10 nanometers to about 1 micrometer. In some embodiments, the fillers are inorganic fillers. Suitable fillers can include, silica, colloidal silica, fumed silica, silica gel, iron oxide, calcium carbonate, calcium sulfate, magnesium carbonate, barium carbonate, barium sulfate, zinc oxide, talc, kaolin, titanium dioxide, lithopone, aluminum oxide, illite, smectite, montmorillonite, quartz, pumice, zeolites, diatomaceous earth, perlite, dolomite, alumina modified colloidal silica, alumina modified fumed silica or a combination thereof. In some embodiments, the filler is colloidal silica, fumed silica or an alumina modified colloidal or fumed silica. In still further embodiments, the filler is LUDOX® AM or AS colloidal silica dispersions, available from W.R. Grace and Company. In some embodiments, the silica can be treated with a relatively thin coating of alumina or titanium dioxide. The thin layer of alumina or titanium dioxide coating can represent in the range of from 0.1 to 50 percent by weight of the silica particle, based on the weight of the uncoated silica particle.

The filler concentration of the coating composition is in the range of from 20 percent to 95 percent by volume, based on the dry coating. In other embodiments, the filler concentration is in the range of from 40 percent to 95 percent by volume and, in still further embodiments, is in the range of from 50 percent to 90 percent by volume. The percentage by volume is based on the volume of the dry coating composition, without the aqueous carrier. In some embodiments, the filler concentration is determined after at least 75 percent of the aqueous carrier has been removed, and, in other embodiments, is determined after at least 90 percent of the aqueous carrier has been removed. In still other embodiments, the filler concentration is determined after substantially all (that is, after at least 95 percent) of the aqueous carrier has been removed from the layer of coating composition. ASTM D2369 is a standard test for determining the amount of volatile content in a coating composition.

In some embodiments, the filler is present in the coating composition at a reduced FVC of greater than or equal to 80 percent and up to about 150 percent. In some embodiments, the filler is present at a reduced FVC of greater than 85 percent, and, in other embodiments, is present at a reduced FVC of greater than 90 percent. The upper level of the reduced FVC is critical only in that at some level of filler concentration above the critical FVC, the film forming binder may not be able to form a layer of the coating composition that has the required properties needed for a propagule coating. For example, the applied layer of coating composition may have too high of a dust-off value or the applied layer of coating composition may not form a continuous coating on the propagule. For practical purposes, the upper level of the reduced FVC is considered to be about 150 percent.

The fillers used in the coating composition are non-water soluble fillers. By non-water soluble is meant that the fillers have a water solubility at 20° C. of less than 100 milligrams per liter of water. It is well-known that fillers can be classified according to their shape. Some of the classification categories include, for example, spherical fillers, flat fillers and fibrous fillers. Spherical fillers do not have to be true spheres, but instead have a length to width to thickness ratio in the range of from 1:1:1 to 4:1:1. Substantially spherical fillers therefore can be spherical, cubic, block-shaped or irregularly shaped. Flat fillers have a length to width to thickness ratio in the range of about 1:1:0.25 to 1:1:0.01. Fibrous fillers have a length to width to thickness ration in the range of about 1:0.1:0.1 to 1:0.01:0.01. Substantially spherical fillers can include, for example, silica, titanium dioxide, iron oxide and others. Examples of flat fillers can include mica, talc, and graphite. Fibrous fillers can include wollastonite and glass fibers. If flat fillers are utilized in the coating composition, it can be necessary to add other fillers, for example, spherical fillers, in an amount that disrupts the ability of flat fillers to pack substantially parallel to one another. In some embodiments, the weight percentage of substantially spherical fillers is greater than or equal to 75 percent, based on the weight of all of the fillers in the coating composition. In other embodiments, the weight percentage of substantially spherical fillers is greater than or equal to 85 percent, and in still further embodiments, the weight percentage of substantially spherical fillers is greater than or equal to 90 percent.

The amount of the filler that is added to the coating composition is important. Water permeability of a coating is a function of the volume fraction of filler in the coating, but it is not a linear function; rather it is substantially sigmoidal. At low FVCs, well below the cFVC, the water permeability will remain constant or decrease slightly as the FVC increases. Near the cFVC the water permeability will rapidly increase as the FVC increases and when the FVC is substantially above the cFVC the water permeability will remain substantially constant as the FVC increases.

Surprisingly it has been found that the higher water permeability created by the higher filler concentration can result in the increased uptake of the pesticide into a resultant plant. It has also been found that when filler is used to increase the water permeability of a coating, the amount of pesticide required to achieve a particular level of uptake into a resultant plant can be reduced relative to the amount of pesticide required to achieve the same level of uptake in a resultant plant when a coating with a lower water permeability is used.

The amount of filler that is present in the layer of the coating composition prior to the addition of the pesticide should be an amount so as to provide a water permeability at least 75 milligrams/25 square centimeters/hour, when the water permeability is measured using the procedure given in the examples section. In other embodiments, the layer of the coating composition prior to the addition of the pesticide has a water permeability of at least 80 milligrams/25 square centimeters/hour, and, in still further embodiments, has a water permeability of at least 90 milligrams/25 square centimeters/hour or at least 100 milligrams/25 square centimeters/hour. Water permeability can be measured using a variant of ASTM D1653-03, which is described above. In some embodiments, the water permeability is determined using a layer of the coating composition that has a thickness in the range of from 38 micrometers to 64 micrometers. The upper limit for the water permeability is flux max, which is determined by measuring the water permeability of the chart paper substrate without any applied layer of coating composition.

The coating composition also comprises an aqueous carrier in an amount in the range of from 5 percent to 90 percent by weight, based on the weight of the coating composition. The phrase “aqueous carrier” means a composition comprising greater than or equal to 50 percent by weight of water and optionally, one or more water-soluble compounds that are liquid at 20° C. and have a normal boiling point of not greater than about 100° C. The optional water-soluble compounds should be nonphytotoxic to the geotropic propagule to be coated. Suitable water-soluble compounds can include, for example, methanol, ethanol, acetone, methyl acetate or a combination thereof. In some embodiments, the aqueous carrier comprises greater than or equal to 80 percent by weight of water and, in still further embodiments, comprises greater than or equal to 90 percent water or greater than or equal to 95 percent water. All percentage by weight of water are based on the total amount of the aqueous carrier.

Prior to application to the propagule, a pesticide is added to the coating composition to form a propagule coating composition. Suitable pesticides are those that are under the jurisdiction of the United States of America Federal Insecticide, Fungicide and Rodenticide Act (FIFRA). In some embodiments, the pesticide can be an insecticide, fungicide, nematicide, herbicide or a combination thereof. In further embodiments, the pesticide can be an insecticide, a fungicide or a combination thereof. The skilled worker is familiar with such pesticides, which can be found, for example, in Pesticide Manual, 15th Ed. (2009), The British Crop Protection Council, London. Certain herbicides are also included in order to control obligate hemiparasites of roots, for example, some species in the genera Orobanche and Striga which require a living host for germination and initial development. In some embodiments, a combination of two or more pesticides can be used. For example, both a fungicide and an insecticide can be present. In other embodiments, two different insecticides can be present, with or without the use of a fungicide. In other embodiments, the pesticide can be a systemic pesticide.

Suitable pesticides can include insecticides, for example, anthranilic diamides, N-oxides, or salts thereof, neonicotinoids, carbamates, diamides, spinosyns, phenylpyrazoles, pyrethroids, sulfoxaflor or a combination thereof. In other embodiments, the insecticide can include, for example, thiamethoxam, clothianidin, imidacloprid, acetamiprid, dinotefuran, nitenpyram, thiacloprid, thiodicarb, aldicarb, carbofuran, furadan, fenoxycarb, carbaryl, sevin, ethienocarb, fenobucarb, chlorantraniliprole, cyantraniliprole, flubendiamide, spinosad, spinetoram, lambda-cyhalothrin, gamma-cyhalothrin, tefluthrin, fipronil, pyrometrizine, deltamethrin, methiocarb, permethrin, fipronil, thiram, or a combination thereof.

The anthranilic diamide class of insecticides contains a very large number of active ingredients and any of those can be used. In some embodiments, the pesticide can be one or more anthranilic diamides, for example, those represented by Formula 1, or N-oxides, or salts thereof;

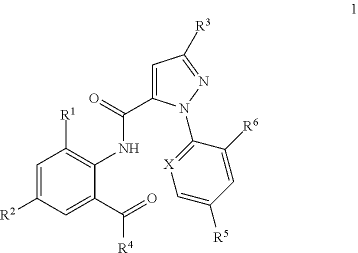

wherein
X is N, CF, CCl, CBr or Cl;
R¹ is CH₃, Cl, Br or F;
R² is H, F, Cl, Br or —CN;
R³ is F, Cl, Br, C1 to C4 haloalkyl, C1 to C4 haloalkoxy or Q;
R⁴ is NR⁷R⁸, N═S(CH₃)₂, N═S(CH₂CH₃)₂, N═S(CH(CH₃)₂)₂;
R⁵ is H, F, Cl or Br;
R⁶ is H, F, Cl or Br;
each R⁷ and R⁸ is independently H, C1 to C6 alkyl, C3 to C6 cycloalkyl, cyclopropylmethyl or 1-cyclopropylethyl; and
Q is a —CH₂-tetrazole radical. Suitable embodiments for Q can include any structure having a formula according to Q-1 to Q-11;

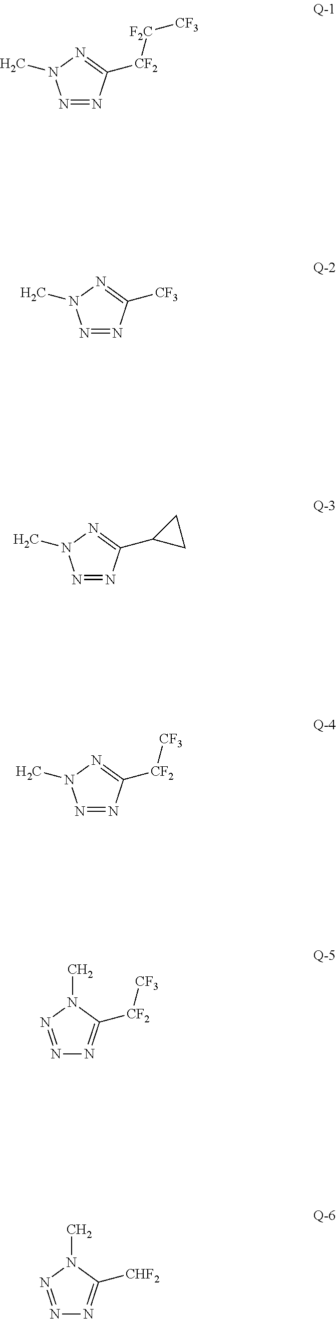

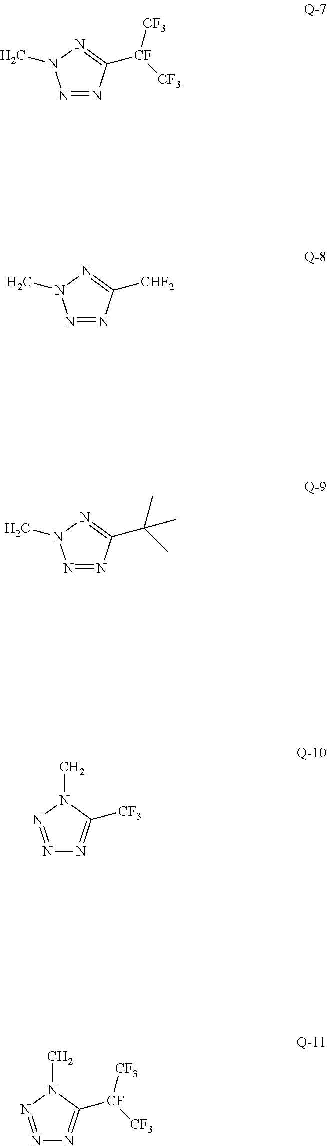

A specific structure wherein Q is Q-2 is shown below in Formula 3;

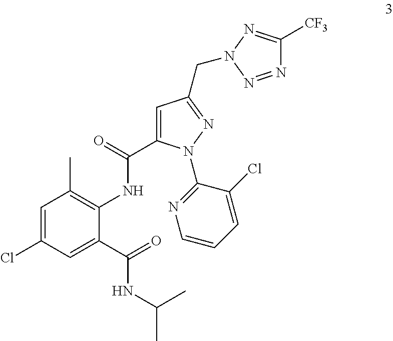 [SMILES: Cc1cc(Cl)cc(C(=O)NC(C)C)c1NC(=O)c1cc(Cn2nnc(C(F)(F)F)n2)nn1-c1ncccc1Cl]

In other embodiments, the pesticide can be one or more anthranilic diamides, for example, those represented by Formula 2, or N-oxides, or salts thereof;

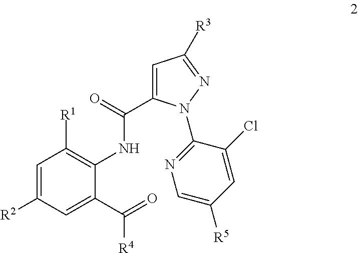

wherein

R¹ is CH₃, Cl, Br or F;

R² is H, F, Cl, Br or —CN;

R³ is F, Cl, Br, C1 to C4 haloalkyl, C1 to C4 haloalkoxy or Q;

R⁴ is NHCH₃, NHCH₂CH₃, NHCH(CH₃)₂, NHC(CH₃)₃, NHCH₂(cyclopropyl), NHCH (cyclopropyl)CH₃, N═S(CH₃)₂, N═S(CH₂CH₃)₂ or N═S(CH(CH₃)₂)₂;

R⁵ is H, F, Cl or Br.

Two specific examples include chlorantraniliprole and cyantraniliprole. Chlorantraniliprole has a water solubility at 20° C. of about 1 milligram per liter. Cyantraniliprole has a water solubility at 20° C. of about 14.2 milligram per liter. Both of these insecticides are available from E.I. du Pont de Nemours and Company, Wilmington, Del.

By procedures known in the art, any of the following compounds in Table I-1 can be produced. In Table I-1, the following abbreviations are used: Me is methyl, Et is ethyl, Pr is propyl, i-Pr is isopropyl, c-Pr is cyclopropyl, t-Bu is tert-butyl.

TABLE I-1

| R¹ | R² | R³ | R⁴ | R⁵ | R¹ | R² | R³ | R⁴ | R⁵ |
|---|---|---|---|---|---|---|---|---|---|
| Me | Cl | Br | —NHMe | H | Me | Cl | Br | —NHMe | Cl |
| Cl | Cl | Br | —NHMe | H | Cl | Cl | Br | —NHMe | Cl |
| Br | Cl | Br | —NHMe | H | Br | Cl | Br | —NHMe | Cl |
| Me | Br | Br | —NHMe | H | Me | Br | Br | —NHMe | Cl |
| Cl | Br | Br | —NHMe | H | Cl | Br | Br | —NHMe | Cl |
| Br | Br | Br | —NHMe | H | Br | Br | Br | —NHMe | Cl |
| Me | CN | Br | —NHMe | H | Me | CN | Br | —NHMe | Cl |
| Cl | CN | Br | —NHMe | H | Cl | CN | Br | —NHMe | Cl |
| Br | CN | Br | —NHMe | H | Br | CN | Br | —NHMe | Cl |
| Me | Cl | Cl | —NHMe | H | Me | Cl | Cl | —NHMe | Cl |
| Cl | Cl | Cl | —NHMe | H | Cl | Cl | Cl | —NHMe | Cl |
| Br | Cl | Cl | —NHMe | H | Br | Cl | Cl | —NHMe | Cl |
| Me | Br | Cl | —NHMe | H | Me | Br | Cl | —NHMe | Cl |
| Cl | Br | Cl | —NHMe | H | Cl | Br | Cl | —NHMe | Cl |
| Br | Br | Cl | —NHMe | H | Br | Br | Cl | —NHMe | Cl |
| Me | CN | Cl | —NHMe | H | Me | CN | Cl | —NHMe | Cl |
| Cl | CN | Cl | —NHMe | H | Cl | CN | Cl | —NHMe | Cl |
| Br | CN | Cl | —NHMe | H | Br | CN | Cl | —NHMe | Cl |
| Me | Cl | CF₃ | —NHMe | H | Me | Cl | CF₃ | —NHMe | Cl |
| Cl | Cl | CF₃ | —NHMe | H | Cl | Cl | CF₃ | —NHMe | Cl |
| Br | Cl | CF₃ | —NHMe | H | Br | Cl | CF₃ | —NHMe | Cl |
| Me | Br | CF₃ | —NHMe | H | Me | Br | CF₃ | —NHMe | Cl |
| Cl | Br | CF₃ | —NHMe | H | Cl | Br | CF₃ | —NHMe | Cl |
| Br | Br | CF₃ | —NHMe | H | Br | Br | CF₃ | —NHMe | Cl |
| Me | CN | CF₃ | —NHMe | H | Me | CN | CF₃ | —NHMe | Cl |
| Cl | CN | CF₃ | —NHMe | H | Cl | CN | CF₃ | —NHMe | Cl |
| Br | CN | CF₃ | —NHMe | H | Br | CN | CF₃ | —NHMe | Cl |
| Me | Cl | Q-2 | —NHMe | H | Me | Cl | Q-2 | —NHMe | Cl |
| Cl | Cl | Q-2 | —NHMe | H | Cl | Cl | Q-2 | —NHMe | Cl |
| Br | Cl | Q-2 | —NHMe | H | Br | Cl | Q-2 | —NHMe | Cl |
| Me | Br | Q-2 | —NHMe | H | Me | Br | Q-2 | —NHMe | Cl |
| Cl | Br | Q-2 | —NHMe | H | Cl | Br | Q-2 | —NHMe | Cl |
| Br | Br | Q-2 | —NHMe | H | Br | Br | Q-2 | —NHMe | Cl |
| Me | CN | Q-2 | —NHMe | H | Me | CN | Q-2 | —NHMe | Cl |
| Cl | CN | Q-2 | —NHMe | H | Cl | CN | Q-2 | —NHMe | Cl |
| Br | CN | Q-2 | —NHMe | H | Br | CN | Q-2 | —NHMe | Cl |
| Me | Cl | Br | —NHEt | H | Me | Cl | Br | —NHEt | Cl |
| Cl | Cl | Br | —NHEt | H | Cl | Cl | Br | —NHEt | Cl |
| Br | Cl | Br | —NHEt | H | Br | Cl | Br | —NHEt | Cl |
| Me | Br | Br | —NHEt | H | Me | Br | Br | —NHEt | Cl |
| Cl | Br | Br | —NHEt | H | Cl | Br | Br | —NHEt | Cl |
| Br | Br | Br | —NHEt | H | Br | Br | Br | —NHEt | Cl |
| Me | CN | Br | —NHEt | H | Me | CN | Br | —NHEt | Cl |
| Cl | CN | Br | —NHEt | H | Cl | CN | Br | —NHEt | Cl |
| Br | CN | Br | —NHEt | H | Br | CN | Br | —NHEt | Cl |
| Me | Cl | Cl | —NHEt | H | Me | Cl | Cl | —NHEt | Cl |
| Cl | Cl | Cl | —NHEt | H | Cl | Cl | Cl | —NHEt | Cl |
| Br | Cl | Cl | —NHEt | H | Br | Cl | Cl | —NHEt | Cl |
| Me | Br | Cl | —NHEt | H | Me | Br | Cl | —NHEt | Cl |
| Cl | Br | Cl | —NHEt | H | Cl | Br | Cl | —NHEt | Cl |
| Br | Br | Cl | —NHEt | H | Br | Br | Cl | —NHEt | Cl |
| Me | CN | Cl | —NHEt | H | Me | CN | Cl | —NHEt | Cl |
| Cl | CN | Cl | —NHEt | H | Cl | CN | Cl | —NHEt | Cl |
| Br | CN | Cl | —NHEt | H | Br | CN | Cl | —NHEt | Cl |
| Me | Cl | CF₃ | —NHEt | H | Me | Cl | CF₃ | —NHEt | Cl |
| Cl | Cl | CF₃ | —NHEt | H | Cl | Cl | CF₃ | —NHEt | Cl |
| Br | Cl | CF₃ | —NHEt | H | Br | Cl | CF₃ | —NHEt | Cl |
| Me | Br | CF₃ | —NHEt | H | Me | Br | CF₃ | —NHEt | Cl |
| Cl | Br | CF₃ | —NHEt | H | Cl | Br | CF₃ | —NHEt | Cl |
| Br | Br | CF₃ | —NHEt | H | Br | Br | CF₃ | —NHEt | Cl |
| Me | CN | CF₃ | —NHEt | H | Me | CN | CF₃ | —NHEt | Cl |
| Cl | CN | CF₃ | —NHEt | H | Cl | CN | CF₃ | —NHEt | Cl |
| Br | CN | CF₃ | —NHEt | H | Br | CN | CF₃ | —NHEt | Cl |
| Me | Cl | Q-2 | —NHEt | H | Me | Cl | Q-2 | —NHEt | Cl |
| Cl | Cl | Q-2 | —NHEt | H | Cl | Cl | Q-2 | —NHEt | Cl |
| Br | Cl | Q-2 | —NHEt | H | Br | Cl | Q-2 | —NHEt | Cl |
| Me | Br | Q-2 | —NHEt | H | Me | Br | Q-2 | —NHEt | Cl |
| Cl | Br | Q-2 | —NHEt | H | Cl | Br | Q-2 | —NHEt | Cl |
| Br | Br | Q-2 | —NHEt | H | Br | Br | Q-2 | —NHEt | Cl |
| Me | CN | Q-2 | —NHEt | H | Me | CN | Q-2 | —NHEt | Cl |
| Cl | CN | Q-2 | —NHEt | H | Cl | CN | Q-2 | —NHEt | Cl |
| Br | CN | Q-2 | —NHEt | H | Br | CN | Q-2 | —NHEt | Cl |
| Me | Cl | Br | —NH(i-Pr) | H | Me | Cl | Br | —NH(i-Pr) | Cl |
| Cl | Cl | Br | —NH(i-Pr) | H | Cl | Cl | Br | —NH(i-Pr) | Cl |
| Br | Cl | Br | —NH(i-Pr) | H | Br | Cl | Br | —NH(i-Pr) | Cl |
| Me | Br | Br | —NH(i-Pr) | H | Me | Br | Br | —NH(i-Pr) | Cl |
| Cl | Br | Br | —NH(i-Pr) | H | Cl | Br | Br | —NH(i-Pr) | Cl |
| Br | Br | Br | —NH(i-Pr) | H | Br | Br | Br | —NH(i-Pr) | Cl |
| Me | CN | Br | —NH(i-Pr) | H | Me | CN | Br | —NH(i-Pr) | Cl |
| Cl | CN | Br | —NH(i-Pr) | H | Cl | CN | Br | —NH(i-Pr) | Cl |
| Br | CN | Br | —NH(i-Pr) | H | Br | CN | Br | —NH(i-Pr) | Cl |
| Me | Cl | Cl | —NH(i-Pr) | H | Me | Cl | Cl | —NH(i-Pr) | Cl |
| Cl | Cl | Cl | —NH(i-Pr) | H | Cl | Cl | Cl | —NH(i-Pr) | Cl |
| Br | Cl | Cl | —NH(i-Pr) | H | Br | Cl | Cl | —NH(i-Pr) | Cl |
| Me | Br | Cl | —NH(i-Pr) | H | Me | Br | Cl | —NH(i-Pr) | Cl |
| Cl | Br | Cl | —NH(i-Pr) | H | Cl | Br | Cl | —NH(i-Pr) | Cl |
| Br | Br | Cl | —NH(i-Pr) | H | Br | Br | Cl | —NH(i-Pr) | Cl |
| Me | CN | Cl | —NH(i-Pr) | H | Me | CN | Cl | —NH(i-Pr) | Cl |
| Cl | CN | Cl | —NH(i-Pr) | H | Cl | CN | Cl | —NH(i-Pr) | Cl |
| Br | CN | Cl | —NH(i-Pr) | H | Br | CN | Cl | —NH(i-Pr) | Cl |
| Me | Cl | CF₃ | —NH(i-Pr) | H | Me | Cl | CF₃ | —NH(i-Pr) | Cl |
| Cl | Cl | CF₃ | —NH(i-Pr) | H | Cl | Cl | CF₃ | —NH(i-Pr) | Cl |
| Br | Cl | CF₃ | —NH(i-Pr) | H | Br | Cl | CF₃ | —NH(i-Pr) | Cl |
| Me | Br | CF₃ | —NH(i-Pr) | H | Me | Br | CF₃ | —NH(i-Pr) | Cl |
| Cl | Br | CF₃ | —NH(i-Pr) | H | Cl | Br | CF₃ | —NH(i-Pr) | Cl |
| Br | Br | CF₃ | —NH(i-Pr) | H | Br | Br | CF₃ | —NH(i-Pr) | Cl |
| Me | CN | CF₃ | —NH(i-Pr) | H | Me | CN | CF₃ | —NH(i-Pr) | Cl |
| Cl | CN | CF₃ | —NH(i-Pr) | H | Cl | CN | CF₃ | —NH(i-Pr) | Cl |
| Br | CN | CF₃ | —NH(i-Pr) | H | Br | CN | CF₃ | —NH(i-Pr) | Cl |
| Me | Cl | Q-2 | —NH(i-Pr) | H | Me | Cl | Q-2 | —NH(i-Pr) | Cl |
| Cl | Cl | Q-2 | —NH(i-Pr) | H | Cl | Cl | Q-2 | —NH(i-Pr) | Cl |
| Br | Cl | Q-2 | —NH(i-Pr) | H | Br | Cl | Q-2 | —NH(i-Pr) | Cl |
| Me | Br | Q-2 | —NH(i-Pr) | H | Me | Br | Q-2 | —NH(i-Pr) | Cl |
| Cl | Br | Q-2 | —NH(i-Pr) | H | Cl | Br | Q-2 | —NH(i-Pr) | Cl |
| Br | Br | Q-2 | —NH(i-Pr) | H | Br | Br | Q-2 | —NH(i-Pr) | Cl |
| Me | CN | Q-2 | —NH(i-Pr) | H | Me | CN | Q-2 | —NH(i-Pr) | Cl |
| Cl | CN | Q-2 | —NH(i-Pr) | H | Cl | CN | Q-2 | —NH(i-Pr) | Cl |
| Br | CN | Q-2 | —NH(i-Pr) | H | Br | CN | Q-2 | —NH(i-Pr) | Cl |
| Me | Cl | Br | —NH(t-Bu) | H | Me | Cl | Br | —NH(t-Bu) | Cl |
| Cl | Cl | Br | —NH(t-Bu) | H | Cl | Cl | Br | —NH(t-Bu) | Cl |
| Br | Cl | Br | —NH(t-Bu) | H | Br | Cl | Br | —NH(t-Bu) | Cl |
| Me | Br | Br | —NH(t-Bu) | H | Me | Br | Br | —NH(t-Bu) | Cl |
| Cl | Br | Br | —NH(t-Bu) | H | Cl | Br | Br | —NH(t-Bu) | Cl |
| Br | Br | Br | —NH(t-Bu) | H | Br | Br | Br | —NH(t-Bu) | Cl |
| Me | CN | Br | —NH(t-Bu) | H | Me | CN | Br | —NH(t-Bu) | Cl |
| Cl | CN | Br | —NH(t-Bu) | H | Cl | CN | Br | —NH(t-Bu) | Cl |
| Br | CN | Br | —NH(t-Bu) | H | Br | CN | Br | —NH(t-Bu) | Cl |
| Me | Cl | Cl | —NH(t-Bu) | H | Me | Cl | Cl | —NH(t-Bu) | Cl |
| Cl | Cl | Cl | —NH(t-Bu) | H | Cl | Cl | Cl | —NH(t-Bu) | Cl |
| Br | Cl | Cl | —NH(t-Bu) | H | Br | Cl | Cl | —NH(t-Bu) | Cl |
| Me | Br | Cl | —NH(t-Bu) | H | Me | Br | Cl | —NH(t-Bu) | Cl |
| Cl | Br | Cl | —NH(t-Bu) | H | Cl | Br | Cl | —NH(t-Bu) | Cl |
| Br | Br | Cl | —NH(t-Bu) | H | Br | Br | Cl | —NH(t-Bu) | Cl |
| Me | CN | Cl | —NH(t-Bu) | H | Me | CN | Cl | —NH(t-Bu) | Cl |
| Cl | CN | Cl | —NH(t-Bu) | H | Cl | CN | Cl | —NH(t-Bu) | Cl |
| Br | CN | Cl | —NH(t-Bu) | H | Br | CN | Cl | —NH(t-Bu) | Cl |
| Me | Cl | CF₃ | —NH(t-Bu) | H | Me | Cl | CF₃ | —NH(t-Bu) | Cl |
| Cl | Cl | CF₃ | —NH(t-Bu) | H | Cl | Cl | CF₃ | —NH(t-Bu) | Cl |
| Br | Cl | CF₃ | —NH(t-Bu) | H | Br | Cl | CF₃ | —NH(t-Bu) | Cl |
| Me | Br | CF₃ | —NH(t-Bu) | H | Me | Br | CF₃ | —NH(t-Bu) | Cl |
| Cl | Br | CF₃ | —NH(t-Bu) | H | Cl | Br | CF₃ | —NH(t-Bu) | Cl |
| Br | Br | CF₃ | —NH(t-Bu) | H | Br | Br | CF₃ | —NH(t-Bu) | Cl |
| Me | CN | CF₃ | —NH(t-Bu) | H | Me | CN | CF₃ | —NH(t-Bu) | Cl |
| Cl | CN | CF₃ | —NH(t-Bu) | H | Cl | CN | CF₃ | —NH(t-Bu) | Cl |
| Br | CN | CF₃ | —NH(t-Bu) | H | Br | CN | CF₃ | —NH(t-Bu) | Cl |
| Me | Cl | Q-2 | —NH(t-Bu) | H | Me | Cl | Q-2 | —NH(t-Bu) | Cl |
| Cl | Cl | Q-2 | —NH(t-Bu) | H | Cl | Cl | Q-2 | —NH(t-Bu) | Cl |
| Br | Cl | Q-2 | —NH(t-Bu) | H | Br | Cl | Q-2 | —NH(t-Bu) | Cl |
| Me | Br | Q-2 | —NH(t-Bu) | H | Me | Br | Q-2 | —NH(t-Bu) | Cl |
| Cl | Br | Q-2 | —NH(t-Bu) | H | Cl | Br | Q-2 | —NH(t-Bu) | Cl |
| Br | Br | Q-2 | —NH(t-Bu) | H | Br | Br | Q-2 | —NH(t-Bu) | Cl |
| Me | CN | Q-2 | —NH(t-Bu) | H | Me | CN | Q-2 | —NH(t-Bu) | Cl |
| Cl | CN | Q-2 | —NH(t-Bu) | H | Cl | CN | Q-2 | —NH(t-Bu) | Cl |
| Br | CN | Q-2 | —NH(t-Bu) | H | Br | CN | Q-2 | —NH(t-Bu) | Cl |
| Me | Cl | Br | —NHCH₂(c-Pr) | H | Me | Cl | Br | —NHCH₂(c-Pr) | Cl |
| Cl | Cl | Br | —NHCH₂(c-Pr) | H | Cl | Cl | Br | —NHCH₂(c-Pr) | Cl |
| Br | Cl | Br | —NHCH₂(c-Pr) | H | Br | Cl | Br | —NHCH₂(c-Pr) | Cl |
| Me | Br | Br | —NHCH₂(c-Pr) | H | Me | Br | Br | —NHCH₂(c-Pr) | Cl |
| Cl | Br | Br | —NHCH₂(c-Pr) | H | Cl | Br | Br | —NHCH₂(c-Pr) | Cl |
| Br | Br | Br | —NHCH₂(c-Pr) | H | Br | Br | Br | —NHCH₂(c-Pr) | Cl |
| Me | CN | Br | —NHCH₂(c-Pr) | H | Me | CN | Br | —NHCH₂(c-Pr) | Cl |
| Cl | CN | Br | —NHCH₂(c-Pr) | H | Cl | CN | Br | —NHCH₂(c-Pr) | Cl |
| Br | CN | Br | —NHCH₂(c-Pr) | H | Br | CN | Br | —NHCH₂(c-Pr) | Cl |
| Me | Cl | Cl | —NHCH₂(c-Pr) | H | Me | Cl | Cl | —NHCH₂(c-Pr) | Cl |
| Cl | Cl | Cl | —NHCH₂(c-Pr) | H | Cl | Cl | Cl | —NHCH₂(c-Pr) | Cl |
| Br | Cl | Cl | —NHCH₂(c-Pr) | H | Br | Cl | Cl | —NHCH₂(c-Pr) | Cl |
| Me | Br | Cl | —NHCH₂(c-Pr) | H | Me | Br | Cl | —NHCH₂(c-Pr) | Cl |
| Cl | Br | Cl | —NHCH₂(c-Pr) | H | Cl | Br | Cl | —NHCH₂(c-Pr) | Cl |
| Br | Br | Cl | —NHCH₂(c-Pr) | H | Br | Br | Cl | —NHCH₂(c-Pr) | Cl |
| Me | CN | Cl | —NHCH₂(c-Pr) | H | Me | CN | Cl | —NHCH₂(c-Pr) | Cl |
| Cl | CN | Cl | —NHCH₂(c-Pr) | H | Cl | CN | Cl | —NHCH₂(c-Pr) | Cl |
| Br | CN | Cl | —NHCH₂(c-Pr) | H | Br | CN | Cl | —NHCH₂(c-Pr) | Cl |
| Me | Cl | CF₃ | —NHCH₂(c-Pr) | H | Me | Cl | CF₃ | —NHCH₂(c-Pr) | Cl |
| Cl | Cl | CF₃ | —NHCH₂(c-Pr) | H | Cl | Cl | CF₃ | —NHCH₂(c-Pr) | Cl |
| Br | Cl | CF₃ | —NHCH₂(c-Pr) | H | Br | Cl | CF₃ | —NHCH₂(c-Pr) | Cl |
| Me | Br | CF₃ | —NHCH₂(c-Pr) | H | Me | Br | CF₃ | —NHCH₂(c-Pr) | Cl |
| Cl | Br | CF₃ | —NHCH₂(c-Pr) | H | Cl | Br | CF₃ | —NHCH₂(c-Pr) | Cl |
| Br | Br | CF₃ | —NHCH₂(c-Pr) | H | Br | Br | CF₃ | —NHCH₂(c-Pr) | Cl |
| Me | CN | CF₃ | —NHCH₂(c-Pr) | H | Me | CN | CF₃ | —NHCH₂(c-Pr) | Cl |
| Cl | CN | CF₃ | —NHCH₂(c-Pr) | H | Cl | CN | CF₃ | —NHCH₂(c-Pr) | Cl |
| Br | CN | CF₃ | —NHCH₂(c-Pr) | H | Br | CN | CF₃ | —NHCH₂(c-Pr) | Cl |
| Me | Cl | Q-2 | —NHCH₂(c-Pr) | H | Me | Cl | Q-2 | —NHCH₂(c-Pr) | Cl |
| Cl | Cl | Q-2 | —NHCH₂(c-Pr) | H | Cl | Cl | Q-2 | —NHCH₂(c-Pr) | Cl |
| Br | Cl | Q-2 | —NHCH₂(c-Pr) | H | Br | Cl | Q-2 | —NHCH₂(c-Pr) | Cl |
| Me | Br | Q-2 | —NHCH₂(c-Pr) | H | Me | Br | Q-2 | —NHCH₂(c-Pr) | Cl |
| Cl | Br | Q-2 | —NHCH₂(c-Pr) | H | Cl | Br | Q-2 | —NHCH₂(c-Pr) | Cl |
| Br | Br | Q-2 | —NHCH₂(c-Pr) | H | Br | Br | Q-2 | —NHCH₂(c-Pr) | Cl |
| Me | CN | Q-2 | —NHCH₂(c-Pr) | H | Me | CN | Q-2 | —NHCH₂(c-Pr) | Cl |
| Cl | CN | Q-2 | —NHCH₂(c-Pr) | H | Cl | CN | Q-2 | —NHCH₂(c-Pr) | Cl |
| Br | CN | Q-2 | —NHCH₂(c-Pr) | H | Br | CN | Q-2 | —NHCH₂(c-Pr) | Cl |
| Me | Cl | Br | —NHCH(c-Pr)Me | H | Me | Cl | Br | —NHCH(c-Pr)Me | Cl |
| Cl | Cl | Br | —NHCH(c-Pr)Me | H | Cl | Cl | Br | —NHCH(c-Pr)Me | Cl |
| Br | Cl | Br | —NHCH(c-Pr)Me | H | Br | Cl | Br | —NHCH(c-Pr)Me | Cl |
| Me | Br | Br | —NHCH(c-Pr)Me | H | Me | Br | Br | —NHCH(c-Pr)Me | Cl |
| Cl | Br | Br | —NHCH(c-Pr)Me | H | Cl | Br | Br | —NHCH(c-Pr)Me | Cl |
| Br | Br | Br | —NHCH(c-Pr)Me | H | Br | Br | Br | —NHCH(c-Pr)Me | Cl |
| Me | CN | Br | —NHCH(c-Pr)Me | H | Me | CN | Br | —NHCH(c-Pr)Me | Cl |
| Cl | CN | Br | —NHCH(c-Pr)Me | H | Cl | CN | Br | —NHCH(c-Pr)Me | Cl |
| Br | CN | Br | —NHCH(c-Pr)Me | H | Br | CN | Br | —NHCH(c-Pr)Me | Cl |
| Me | Cl | Cl | —NHCH(c-Pr)Me | H | Me | Cl | Cl | —NHCH(c-Pr)Me | Cl |
| Cl | Cl | Cl | —NHCH(c-Pr)Me | H | Cl | Cl | Cl | —NHCH(c-Pr)Me | Cl |
| Br | Cl | Cl | —NHCH(c-Pr)Me | H | Br | Cl | Cl | —NHCH(c-Pr)Me | Cl |
| Me | Br | Cl | —NHCH(c-Pr)Me | H | Me | Br | Cl | —NHCH(c-Pr)Me | Cl |
| Cl | Br | Cl | —NHCH(c-Pr)Me | H | Cl | Br | Cl | —NHCH(c-Pr)Me | Cl |
| Br | Br | Cl | —NHCH(c-Pr)Me | H | Br | Br | Cl | —NHCH(c-Pr)Me | Cl |
| Me | CN | Cl | —NHCH(c-Pr)Me | H | Me | CN | Cl | —NHCH(c-Pr)Me | Cl |
| Cl | CN | Cl | —NHCH(c-Pr)Me | H | Cl | CN | Cl | —NHCH(c-Pr)Me | Cl |
| Br | CN | Cl | —NHCH(c-Pr)Me | H | Br | CN | Cl | —NHCH(c-Pr)Me | Cl |
| Me | Cl | CF₃ | —NHCH(c-Pr)Me | H | Me | Cl | CF₃ | —NHCH(c-Pr)Me | Cl |
| Cl | Cl | CF₃ | —NHCH(c-Pr)Me | H | Cl | Cl | CF₃ | —NHCH(c-Pr)Me | Cl |
| Br | Cl | CF₃ | —NHCH(c-Pr)Me | H | Br | Cl | CF₃ | —NHCH(c-Pr)Me | Cl |
| Me | Br | CF₃ | —NHCH(c-Pr)Me | H | Me | Br | CF₃ | —NHCH(c-Pr)Me | Cl |
| Cl | Br | CF₃ | —NHCH(c-Pr)Me | H | Cl | Br | CF₃ | —NHCH(c-Pr)Me | Cl |
| Br | Br | CF₃ | —NHCH(c-Pr)Me | H | Br | Br | CF₃ | —NHCH(c-Pr)Me | Cl |
| Me | CN | CF₃ | —NHCH(c-Pr)Me | H | Me | CN | CF₃ | —NHCH(c-Pr)Me | Cl |
| Cl | CN | CF₃ | —NHCH(c-Pr)Me | H | Cl | CN | CF₃ | —NHCH(c-Pr)Me | Cl |
| Br | CN | CF₃ | —NHCH(c-Pr)Me | H | Br | CN | CF₃ | —NHCH(c-Pr)Me | Cl |
| Me | Cl | Q-2 | —NHCH(c-Pr)Me | H | Me | Cl | Q-2 | —NHCH(c-Pr)Me | Cl |
| Cl | Cl | Q-2 | —NHCH(c-Pr)Me | H | Cl | Cl | Q-2 | —NHCH(c-Pr)Me | Cl |
| Br | Cl | Q-2 | —NHCH(c-Pr)Me | H | Br | Cl | Q-2 | —NHCH(c-Pr)Me | Cl |
| Me | Br | Q-2 | —NHCH(c-Pr)Me | H | Me | Br | Q-2 | —NHCH(c-Pr)Me | Cl |
| Cl | Br | Q-2 | —NHCH(c-Pr)Me | H | Cl | Br | Q-2 | —NHCH(c-Pr)Me | Cl |
| Br | Br | Q-2 | —NHCH(c-Pr)Me | H | Br | Br | Q-2 | —NHCH(c-Pr)Me | Cl |
| Me | CN | Q-2 | —NHCH(c-Pr)Me | H | Me | CN | Q-2 | —NHCH(c-Pr)Me | Cl |
| Cl | CN | Q-2 | —NHCH(c-Pr)Me | H | Cl | CN | Q-2 | —NHCH(c-Pr)Me | Cl |
| Br | CN | Q-2 | —NHCH(c-Pr)Me | H | Br | CN | Q-2 | —NHCH(c-Pr)Me | Cl |
| Me | Cl | Br | —N═S(Me)₂ | H | Me | Cl | Br | —N═S(Me)₂ | Cl |
| Cl | Cl | Br | —N═S(Me)₂ | H | Cl | Cl | Br | —N═S(Me)₂ | Cl |
| Br | Cl | Br | —N═S(Me)₂ | H | Br | Cl | Br | —N═S(Me)₂ | Cl |
| Me | Br | Br | —N═S(Me)₂ | H | Me | Br | Br | —N═S(Me)₂ | Cl |
| Cl | Br | Br | —N═S(Me)₂ | H | Cl | Br | Br | —N═S(Me)₂ | Cl |
| Br | Br | Br | —N═S(Me)₂ | H | Br | Br | Br | —N═S(Me)₂ | Cl |
| Me | CN | Br | —N═S(Me)₂ | H | Me | CN | Br | —N═S(Me)₂ | Cl |
| Cl | CN | Br | —N═S(Me)₂ | H | Cl | CN | Br | —N═S(Me)₂ | Cl |
| Br | CN | Br | —N═S(Me)₂ | H | Br | CN | Br | —N═S(Me)₂ | Cl |
| Me | Cl | Cl | —N═S(Me)₂ | H | Me | Cl | Cl | —N═S(Me)₂ | Cl |
| Cl | Cl | Cl | —N═S(Me)₂ | H | Cl | Cl | Cl | —N═S(Me)₂ | Cl |
| Br | Cl | Cl | —N═S(Me)₂ | H | Br | Cl | Cl | —N═S(Me)₂ | Cl |
| Me | Br | Cl | —N═S(Me)₂ | H | Me | Br | Cl | —N═S(Me)₂ | Cl |
| Cl | Br | Cl | —N═S(Me)₂ | H | Cl | Br | Cl | —N═S(Me)₂ | Cl |
| Br | Br | Cl | —N═S(Me)₂ | H | Br | Br | Cl | —N═S(Me)₂ | Cl |
| Me | CN | Cl | —N═S(Me)₂ | H | Me | CN | Cl | —N═S(Me)₂ | Cl |
| Cl | CN | Cl | —N═S(Me)₂ | H | Cl | CN | Cl | —N═S(Me)₂ | Cl |
| Br | CN | Cl | —N═S(Me)₂ | H | Br | CN | Cl | —N═S(Me)₂ | Cl |
| Me | Cl | CF₃ | —N═S(Me)₂ | H | Me | Cl | CF₃ | —N═S(Me)₂ | Cl |
| Cl | Cl | CF₃ | —N═S(Me)₂ | H | Cl | Cl | CF₃ | —N═S(Me)₂ | Cl |
| Br | Cl | CF₃ | —N═S(Me)₂ | H | Br | Cl | CF₃ | —N═S(Me)₂ | Cl |
| Me | Br | CF₃ | —N═S(Me)₂ | H | Me | Br | CF₃ | —N═S(Me)₂ | Cl |
| Cl | Br | CF₃ | —N═S(Me)₂ | H | Cl | Br | CF₃ | —N═S(Me)₂ | Cl |
| Br | Br | CF₃ | —N═S(Me)₂ | H | Br | Br | CF₃ | —N═S(Me)₂ | Cl |
| Me | CN | CF₃ | —N═S(Me)₂ | H | Me | CN | CF₃ | —N═S(Me)₂ | Cl |
| Cl | CN | CF₃ | —N═S(Me)₂ | H | Cl | CN | CF₃ | —N═S(Me)₂ | Cl |
| Br | CN | CF₃ | —N═S(Me)₂ | H | Br | CN | CF₃ | —N═S(Me)₂ | Cl |
| Me | Cl | Q-2 | —N═S(Me)₂ | H | Me | Cl | Q-2 | —N═S(Me)₂ | Cl |
| Cl | Cl | Q-2 | —N═S(Me)₂ | H | Cl | Cl | Q-2 | —N═S(Me)₂ | Cl |
| Br | Cl | Q-2 | —N═S(Me)₂ | H | Br | Cl | Q-2 | —N═S(Me)₂ | Cl |
| Me | Br | Q-2 | —N═S(Me)₂ | H | Me | Br | Q-2 | —N═S(Me)₂ | Cl |
| Cl | Br | Q-2 | —N═S(Me)₂ | H | Cl | Br | Q-2 | —N═S(Me)₂ | Cl |
| Br | Br | Q-2 | —N═S(Me)₂ | H | Br | Br | Q-2 | —N═S(Me)₂ | Cl |
| Me | CN | Q-2 | —N═S(Me)₂ | H | Me | CN | Q-2 | —N═S(Me)₂ | Cl |
| Cl | CN | Q-2 | —N═S(Me)₂ | H | Cl | CN | Q-2 | —N═S(Me)₂ | Cl |
| Br | CN | Q-2 | —N═S(Me)₂ | H | Br | CN | Q-2 | —N═S(Me)₂ | Cl |
| Me | Cl | Br | —N═S(Et)₂ | H | Me | Cl | Br | —N═S(Et)₂ | Cl |
| Cl | Cl | Br | —N═S(Et)₂ | H | Cl | Cl | Br | —N═S(Et)₂ | Cl |
| Br | Cl | Br | —N═S(Et)₂ | H | Br | Cl | Br | —N═S(Et)₂ | Cl |
| Me | Br | Br | —N═S(Et)₂ | H | Me | Br | Br | —N═S(Et)₂ | Cl |
| Cl | Br | Br | —N═S(Et)₂ | H | Cl | Br | Br | —N═S(Et)₂ | Cl |
| Br | Br | Br | —N═S(Et)₂ | H | Br | Br | Br | —N═S(Et)₂ | Cl |
| Me | CN | Br | —N═S(Et)₂ | H | Me | CN | Br | —N═S(Et)₂ | Cl |
| Cl | CN | Br | —N═S(Et)₂ | H | Cl | CN | Br | —N═S(Et)₂ | Cl |
| Br | CN | Br | —N═S(Et)₂ | H | Br | CN | Br | —N═S(Et)₂ | Cl |
| Me | Cl | Cl | —N═S(Et)₂ | H | Me | Cl | Cl | —N═S(Et)₂ | Cl |
| Cl | Cl | Cl | —N═S(Et)₂ | H | Cl | Cl | Cl | —N═S(Et)₂ | Cl |
| Br | Cl | Cl | —N═S(Et)₂ | H | Br | Cl | Cl | —N═S(Et)₂ | Cl |
| Me | Br | Cl | —N═S(Et)₂ | H | Me | Br | Cl | —N═S(Et)₂ | Cl |
| Cl | Br | Cl | —N═S(Et)₂ | H | Cl | Br | Cl | —N═S(Et)₂ | Cl |
| Br | Br | Cl | —N═S(Et)₂ | H | Br | Br | Cl | —N═S(Et)₂ | Cl |
| Me | CN | Cl | —N═S(Et)₂ | H | Me | CN | Cl | —N═S(Et)₂ | Cl |
| Cl | CN | Cl | —N═S(Et)₂ | H | Cl | CN | Cl | —N═S(Et)₂ | Cl |
| Br | CN | Cl | —N═S(Et)₂ | H | Br | CN | Cl | —N═S(Et)₂ | Cl |
| Me | Cl | CF₃ | —N═S(Et)₂ | H | Me | Cl | CF₃ | —N═S(Et)₂ | Cl |
| Cl | Cl | CF₃ | —N═S(Et)₂ | H | Cl | Cl | CF₃ | —N═S(Et)₂ | Cl |
| Br | Cl | CF₃ | —N═S(Et)₂ | H | Br | Cl | CF₃ | —N═S(Et)₂ | Cl |
| Me | Br | CF₃ | —N═S(Et)₂ | H | Me | Br | CF₃ | —N═S(Et)₂ | Cl |
| Cl | Br | CF₃ | —N═S(Et)₂ | H | Cl | Br | CF₃ | —N═S(Et)₂ | Cl |
| Br | Br | CF₃ | —N═S(Et)₂ | H | Br | Br | CF₃ | —N═S(Et)₂ | Cl |
| Me | CN | CF₃ | —N═S(Et)₂ | H | Me | CN | CF₃ | —N═S(Et)₂ | Cl |
| Cl | CN | CF₃ | —N═S(Et)₂ | H | Cl | CN | CF₃ | —N═S(Et)₂ | Cl |
| Br | CN | CF₃ | —N═S(Et)₂ | H | Br | CN | CF₃ | —N═S(Et)₂ | Cl |
| Me | Cl | Q-2 | —N═S(Et)₂ | H | Me | Cl | Q-2 | —N═S(Et)₂ | Cl |
| Cl | Cl | Q-2 | —N═S(Et)₂ | H | Cl | Cl | Q-2 | —N═S(Et)₂ | Cl |
| Br | Cl | Q-2 | —N═S(Et)₂ | H | Br | Cl | Q-2 | —N═S(Et)₂ | Cl |
| Me | Br | Q-2 | —N═S(Et)₂ | H | Me | Br | Q-2 | —N═S(Et)₂ | Cl |
| Cl | Br | Q-2 | —N═S(Et)₂ | H | Cl | Br | Q-2 | —N═S(Et)₂ | Cl |
| Br | Br | Q-2 | —N═S(Et)₂ | H | Br | Br | Q-2 | —N═S(Et)₂ | Cl |
| Me | CN | Q-2 | —N═S(Et)₂ | H | Me | CN | Q-2 | —N═S(Et)₂ | Cl |
| Cl | CN | Q-2 | —N═S(Et)₂ | H | Cl | CN | Q-2 | —N═S(Et)₂ | Cl |
| Br | CN | Q-2 | —N═S(Et)₂ | H | Br | CN | Q-2 | —N═S(Et)₂ | Cl |
| Me | Cl | Br | —N═S(i-Pr)₂ | H | Me | Cl | Br | —N═S(i-Pr)₂ | Cl |
| Cl | Cl | Br | —N═S(i-Pr)₂ | H | Cl | Cl | Br | —N═S(i-Pr)₂ | Cl |
| Br | Cl | Br | —N═S(i-Pr)₂ | H | Br | Cl | Br | —N═S(i-Pr)₂ | Cl |
| Me | Br | Br | —N═S(i-Pr)₂ | H | Me | Br | Br | —N═S(i-Pr)₂ | Cl |
| Cl | Br | Br | —N═S(i-Pr)₂ | H | Cl | Br | Br | —N═S(i-Pr)₂ | Cl |
| Br | Br | Br | —N═S(i-Pr)₂ | H | Br | Br | Br | —N═S(i-Pr)₂ | Cl |
| Me | CN | Br | —N═S(i-Pr)₂ | H | Me | CN | Br | —N═S(i-Pr)₂ | Cl |
| Cl | CN | Br | —N═S(i-Pr)₂ | H | Cl | CN | Br | —N═S(i-Pr)₂ | Cl |
| Br | CN | Br | —N═S(i-Pr)₂ | H | Br | CN | Br | —N═S(i-Pr)₂ | Cl |
| Me | Cl | Cl | —N═S(i-Pr)₂ | H | Me | Cl | Cl | —N═S(i-Pr)₂ | Cl |
| Cl | Cl | Cl | —N═S(i-Pr)₂ | H | Cl | Cl | Cl | —N═S(i-Pr)₂ | Cl |
| Br | Cl | Cl | —N═S(i-Pr)₂ | H | Br | Cl | Cl | —N═S(i-Pr)₂ | Cl |
| Me | Br | Cl | —N═S(i-Pr)₂ | H | Me | Br | Cl | —N═S(i-Pr)₂ | Cl |
| Cl | Br | Cl | —N═S(i-Pr)₂ | H | Cl | Br | Cl | —N═S(i-Pr)₂ | Cl |
| Br | Br | Cl | —N═S(i-Pr)₂ | H | Br | Br | Cl | —N═S(i-Pr)₂ | Cl |
| Me | CN | Cl | —N═S(i-Pr)₂ | H | Me | CN | Cl | —N═S(i-Pr)₂ | Cl |
| Cl | CN | Cl | —N═S(i-Pr)₂ | H | Cl | CN | Cl | —N═S(i-Pr)₂ | Cl |
| Br | CN | Cl | —N═S(i-Pr)₂ | H | Br | CN | Cl | —N═S(i-Pr)₂ | Cl |
| Me | Cl | CF₃ | —N═S(i-Pr)₂ | H | Me | Cl | CF₃ | —N═S(i-Pr)₂ | Cl |
| Cl | Cl | CF₃ | —N═S(i-Pr)₂ | H | Cl | Cl | CF₃ | —N═S(i-Pr)₂ | Cl |
| Br | Cl | CF₃ | —N═S(i-Pr)₂ | H | Br | Cl | CF₃ | —N═S(i-Pr)₂ | Cl |
| Me | Br | CF₃ | —N═S(i-Pr)₂ | H | Me | Br | CF₃ | —N═S(i-Pr)₂ | Cl |
| Cl | Br | CF₃ | —N═S(i-Pr)₂ | H | Cl | Br | CF₃ | —N═S(i-Pr)₂ | Cl |
| Br | Br | CF₃ | —N═S(i-Pr)₂ | H | Br | Br | CF₃ | —N═S(i-Pr)₂ | Cl |
| Me | CN | CF₃ | —N═S(i-Pr)₂ | H | Me | CN | CF₃ | —N═S(i-Pr)₂ | Cl |
| Cl | CN | CF₃ | —N═S(i-Pr)₂ | H | Cl | CN | CF₃ | —N═S(i-Pr)₂ | Cl |
| Br | CN | CF₃ | —N═S(i-Pr)₂ | H | Br | CN | CF₃ | —N═S(i-Pr)₂ | Cl |
| Me | Cl | Q-2 | —N═S(i-Pr)₂ | H | Me | Cl | Q-2 | —N═S(i-Pr)₂ | Cl |
| Cl | Cl | Q-2 | —N═S(i-Pr)₂ | H | Cl | Cl | Q-2 | —N═S(i-Pr)₂ | Cl |
| Br | Cl | Q-2 | —N═S(i-Pr)₂ | H | Br | Cl | Q-2 | —N═S(i-Pr)₂ | Cl |
| Me | Br | Q-2 | —N═S(i-Pr)₂ | H | Me | Br | Q-2 | —N═S(i-Pr)₂ | Cl |
| Cl | Br | Q-2 | —N═S(i-Pr)₂ | H | Cl | Br | Q-2 | —N═S(i-Pr)₂ | Cl |
| Br | Br | Q-2 | —N═S(i-Pr)₂ | H | Br | Br | Q-2 | —N═S(i-Pr)₂ | Cl |
| Me | CN | Q-2 | —N═S(i-Pr)₂ | H | Me | CN | Q-2 | —N═S(i-Pr)₂ | Cl |
| Cl | CN | Q-2 | —N═S(i-Pr)₂ | H | Cl | CN | Q-2 | —N═S(i-Pr)₂ | Cl |
| Br | CN | Q-2 | —N═S(i-Pr)₂ | H | Br | CN | Q-2 | —N═S(i-Pr)₂ | Cl |

In other embodiments, the pesticides can be other known anthranilic diamide insecticides, for example, those described in U.S. Pat. No. 8,324,390, US 2010/0048640, WO 2007/006670, WO 2013/024009, WO 2013/024010, WO 2013/024004, WO 2013/024170 or WO 2013/024003. Specific embodiments from U.S. Pat. No. 8,324,390 can include any of those compounds disclosed as examples 1 through 544. Specific embodiments from US 2010/0048640 can include any of those compounds disclosed in Tables 1 through 68 or compounds represented by Chemical Formula 44 through 118. Each of the references to the above patents and applications are hereby incorporated by reference.

Nematicides can also be included as a pesticide of the propagule coating composition. Suitable examples can include, for example, avermectin nematicides, carbamate nematicides, and organophosphorous nematicides, abamectin, emamectin benzoate, benomyl, carbofuran, carbosulfan, cloethocarb, alanycarb, aldicarb, aldoxycarb, oxamyl, tirpate, diamidafos, fenamiphos, fosthietan, phosphamidon, cadusafos, chlorpyrifos, dichlofenthion, dimethoate, ethoprophos, fensulfothion, fosthiazate, heterophos, isamidofos, isazofos, phorate, phosphocarb, terbufos, thionazin, triazophos, imicyafos, mecarphon, acteoprole, benclothiay, chloropicrin, dazomet, fluensulfone, furfural, metam, methyl iodide, methyl isothiocyanate, xylenols, and a combination thereof. Nematicides also include nematicidally active biological organisms such as a bacteria or fungus. For example, Bacillus firmus, Bacillus cereus, Bacillus spp, Pasteuria spp, Pochonia chlamydosporia, Pochonia spp, and Streptomyces spp. A preferred nematicide according to an embodiment of the present invention is abamectin.

Fungicides can also be included in the propagule coating composition. Suitable fungicides can include, for example, strobilurin fungicides, azole fungicides, conazole fungicides, triazole fungicides, amide fungicides, benzothiadiazole fungicides or a combination thereof. In other embodiments, the fungicides can include, azoyxstrobin, paclobutrazol, difenoconazole, isopyrazam, epoxiconazole, acibenzolar, acibenzolar-S-methyl, chlorothalonil, cyprodinil, fludioxonil, mandipropamid, picoxystrobin, propiconazole, pyraclostrobin, tebuconazole, thiabendazole, trifloxystrobin, mancozeb, chlorothalonil, metalaxyl-M (mefenoxam), metalaxyl, ametoctradin, prothioconazole, triadimenol, cyproconazole, sedaxane, cyprodinil, penconazole, boscalid, bixafen, fluopyram, penthiopyrad, fluazinam, fenpropidin, cyflufenamid, tebuconazole, trifloxystrobin, fluxapyroxad, penflufen, fluoxastrobin, kresoxim-methyl, benthiavalicarb, dimethomorph, amisulbrom, cyazofamid, flusulfamide, methyl thiophanate, triticonazole, flutriafol, thiram, tetraconazole, clothianidin, carboxin, thiodicarb, carbendazim, ipconazole, imazalil, penflufen, or a combination thereof. In still further embodiments, the fungicide can include fludioxonil, metalaxyl-M or a combination thereof.

The pesticide can be present in the propagule coating composition in the range of from 0.1 percent to 80 percent by weight, wherein the percentage by weight is based on the total weight of the propagule coating composition. In other embodiments, the pesticide can be present in the range of from 10 percent to 75 percent by weight and, in still further embodiments, the pesticide can be present in the range of from 20 percent to 50 percent by weight, wherein each of the percentages by weight are based on the total weight of the propagule coating composition. The present disclosure is particularly suitable for those pesticides that have a relatively low water solubility. In some embodiments, the pesticide has a water solubility at 20° C. in the range of from 0.001 milligrams per liter of water to 1000 milligrams per liter of water. In other embodiments, the water solubility at 20° C. is in the range of from 0.001 milligrams per liter of water to about 100 milligrams per liter and, in still further embodiments, the water solubility at 20° C. is in the range of from 0.001 milligrams per liter of water to about 50 milligrams per liter.

The coating composition, as stated previously, has a water permeability of at least 75 milligrams/25 square centimeter/hour and up to flux max. The addition of the pesticide to the coating composition results in the formation of the propagule coating composition. A layer of the propagule coating composition has a water permeability that is not less than 75 milligrams/25 square centimeter/hour. In some embodiments, a layer of the propagule coating composition has a water permeability of not less than 75 milligrams/25 square centimeters/hour to flux max. This does not mean that the water permeability of a layer of the propagule coating composition does not change when compared to a layer of the coating composition, but that the water permeability does not fall below 75 milligrams/25 square centimeter/hour. In other embodiments, a layer of the propagule coating composition has a water permeability in the range of from 80 milligrams/25 square centimeters/hour to flux max. In still further embodiments, a layer of the propagule coating composition can have a water permeability in the range of from 90 milligrams/25 square centimeters/hour to flux max or in the range of from 100 milligrams/25 square centimeters/hour to flux max.

The coating composition and/or the propagule coating composition can also comprise other additives that are common in propagule coating compositions. For example, pigments, dyes, biologically active agents other than the pesticides listed above, liquid diluents, dispersing agents, surfactants, wetting agents, antifreeze agents, preservatives, fertilizers or a combination thereof. In the following paragraphs that discuss each of the additives that are common in propagule coating compositions, the coating composition will be generically referred to as coating compositions. It should be noted that either the coating composition can comprises one or more of the additives, or, the additives can be added to the propagule coating composition.

Suitable dyes or pigments are well known in the art and can include, for example, anthraquinone, triphenylmethane, phthalocyanine and derivatives thereof, and diazonium salts. Pigments can include, for example, red 112, pigment red 2, pigment red 48:2, pigment blue 15:3, pigment green 36, pigment green 7, pigment yellow 74, pigment orange 5, pigment black 7, pigment violet 23, pigment white 6 or a combination thereof.

Biologically active agents other than pesticides can include, for example, fungicides, bactericidal agents, microorganisms, plant growth regulators, plant hormones, germination stimulants, pheromones, or a combination thereof. Examples of each of these biologically active agents are known in the art and can be used in the coating compositions.

The coating compositions can optionally include one or more liquid diluents. The term “liquid diluent” excludes water unless otherwise indicated. When the coating composition comprises one or more liquid diluents, they generally amount to in the range of from about 0.1 percent to about 5 percent of the total weight of the coating composition. Typically, the liquid diluents are relatively nonvolatile, i.e., have a normal boiling point of greater than about 100° C., preferably greater than about 200° C. Examples of liquid diluents include N-alkylpyrrolidones, dimethyl sulfoxide, ethylene glycol, polypropylene glycol, propylene carbonate, dibasic esters, paraffins, alkylnaphthalenes, oils of olive, castor, linseed, tung, sesame, corn, peanut, cottonseed, soybean, rapeseed and coconut, fatty acid esters, ketones such as isophorone and 4-hydroxy-4-methyl-2-pentanone, and alcohols such as cyclohexanol, decanol, benzyl alcohol, tetrahydrofurfuryl alcohol or a combination thereof. Typical liquid diluents are described in Marsden, Solvents Guide, 2nd Ed., Interscience, New York, 1950. As the presence of liquid diluents can soften the composition coating a propagule, the coating composition typically comprises not more than about 5 percent of liquid diluents by weight.

The disclosed coating compositions can optionally include one or more dispersing agents and/or surfactants. Examples of dispersing agents include anionic surfactants such as phosphate esters of tristyrylphenol ethoxylates (e.g., SOPROPHOR® 3D33 surfactant, available from Solvay-Rhodia, Bristol, Pa.), alkylarylsulfonic acids and their salts (e.g., SUPRAGIL® MNS90 surfactant, also available from Solvay-Rhodia), lignin sulfonates (e.g., ammonium lignosulfonate or sodium lignosulfonate), polyphenol sulfonates, polyacrylic acids, acrylic graft copolymers such as acrylic acid/methyl methacrylate/polyoxyethylene graft copolymers (e.g., ATLOX® 4913 surfactant, available from Croda Inc, Edison, N.J.), other polymers combining polyoxyalkylene with acid functionality such as ATLOX® 4912 surfactant (also available from Croda Inc), ethoxylated alcohols, ethoxylated alkylphenols, ethoxylated sorbitan fatty acid esters, ethoxylated sorbitol fatty acid esters, ethoxylated amines, ethoxylated fatty acids and esters (including ethoxylated vegetable oils), organosilicones, N,N-dialkyltaurates, glycol esters, formaldehyde condensates or a combination thereof.

Examples of surfactants include wetting agents (some of which can also be used as dispersing agents), such as, alkyl sulfate salts, sodium lauryl sulfate, alkyl ether sulfate salts (e.g., sodium lauryl ether sulfate), alkylarylsulfonates (i.e., salts of alkylarylsulfonic acids, including arylsulfonic acids substituted with more than one alkyl moiety) such as sodium or calcium alkylbenzenesulfonates, alkylnaphthalenesulfonates, α-olefin sulfonate salts, dialkyl sulfosuccinate salts, salts of polycarboxylic acids or a combination thereof.

The disclosed coating compositions can also comprise one or more anti-foaming agents. Suitable anti-foaming agents include silicone oils, mineral oils, polydialkylsiloxanes such as polydimethylsiloxanes, fatty acids and their salts with polyvalent cations such as calcium, magnesium and aluminum, alkyne diols (e.g., SURFYNOL® 104 defoamer, available from Air Products, Allentown, Pa.), and fluoroaliphatic esters, perfluoroalkylphosphonic and perfluoroalkylphosphinic acids, and salts thereof. When the coating compositions comprise one or more anti-foaming agents, they can be used in amounts in the range of from about 0.01 percent to about 3 percent by weight, based on the total weight of the coating composition. More typically, anti-foaming agents are not more than about 2 percent and most typically not more than about 1 percent of the total weight of the coating composition.

The coating composition can also optionally comprise one or more antifreeze agents. Antifreeze agents prevent freezing of the coating compositions before the application of a layer of the propagule coating composition on propagules. Suitable antifreeze agents can include, for example, glycols such as ethylene glycol, diethylene glycol, propylene glycol, dipropylene glycol, glycerol, 1,3-propanediol, 1,2-propanediol and polyethylene glycol of molecular weight in the range from about 200 to about 1000 daltons. Antifreeze agents of note for the composition of the present invention include ethylene glycol, propylene glycol, glycerol, 1,3-propanediol and 1,2-propanediol. When the coating compositions comprise one or more antifreeze agents, they typically are used in an amount in the range of from about 0.1 percent to about 14 percent by weight, based on the total weight of the coating composition. In other embodiments, the antifreeze agents are used in an amount of less than about 10 percent by weight, and in other embodiments, are used in an amount of less than about 8 percent by weight, based on the total weight of the coating composition.

The coating composition can optionally comprise a preservative constituent consisting essentially of one or more stabilizing agents or biocides, and the amount of the preservative constituent in the coating composition can be up to about 1 percent by weight, based on the total weight of the coating composition. When a preservative constituent is present, it can be used in amounts in the range of from about 0.01 percent by weight, based on the total weight of the coating composition. The preservative constituent does not exceed typically about 1%, more typically about 0.5% and most typically about 0.3% of the total weight of the coating composition.

Suitable preservatives can include, for example, anti-oxidants (such as butylhydroxytoluene) or pH modifiers (such as citric acid or acetic acid) can prevent decomposition of one or more ingredients during storage of the coating composition. Biocides can prevent or reduce microbial contamination within the coating composition. Particularly suitable biocides are bactericides, for example 5-chloro-2-methyl-3(2H)-isothiazolone, 2-methyl-3(2H)-isothiazolone, EDTA (ethylenediaminetetra-acetic acid), formaldehyde, benzoic acid, and 1,2-benzisothiazol-3(2H)-one or its salts. Combinations thereof are also suitable.

The coating composition can also include one or more thickening agents. Thickening agents (i.e., thickeners) can increase the viscosity of the coating composition. By increasing viscosity, the propensity of filler to settle is reduced. Because fillers can also increase viscosity, including one or more thickening agents is generally not necessary and can be unhelpful if the viscosity of the coating composition is already at the desired level. Suitable thickening agents can include, for example, polyols such as glycerol, polysaccharides including heteropolysaccharides such as xanthan gum. Glycerol can be used and provides both antifreeze and thickening properties. An extensive list of thickeners and their applications can be found in McCutcheon's 2005, Volume 2: Functional Materials published by MC Publishing Company. If the coating composition comprises one or more thickening agents, they can be used in amounts in the range of from about 0.1 percent to about 5 percent by weight, based on the total weight of the coating composition.

The coating composition can also comprise one or more fertilizers. Suitable fertilizers can include, for example, nitrogen, phosphorus and potassium and/or micronutrients such as manganese, iron, zinc and molybdenum. If one or more fertilizers are present, they typically can be used in amount in the range of from about 0.1 percent to about 20 percent by weight, based on the total weight of the coating composition.

The propagule coating composition can be prepared by forming a mixture of the film forming binder, the filler, the pesticide, the aqueous carrier and any optional additives and agitating the mixture. Any of the other additives can be added to the coating composition, to the propagule coating composition or to both. The additives can be added at the same time as the pesticide is added to the coating composition or they can be added at various intervals of the mixing process. Typically, all of the ingredients of the propagule coating composition are added to a suitable mixing vessel and then agitated. In other embodiments, the ingredients of the propagule coating composition can be added in a sequential manner.

The disclosure also relates to propagules comprising a layer of the coating composition. Virtually all propagules can be coated with a layer of the coating composition. Suitable propagules can include, for example, wheat (Triticum aestivum L.), durum wheat (Triticum durum Desf.), barley (Hordeum vulgare L.), oat (Avena sativa L.), rye (Secale cereale L.), maize (Zea mays L.), sorghum (Sorghum vulgare Pers.), rice (Oryza sativa L.), wild rice (Zizania aquatica L.), cotton (Gossypium barbadense L. and G. hirsutum L.), flax (Linum usitatissimum L.), sunflower (Helianthus annuus L.), soybean (Glycine max Merr.), garden bean (Phaseolus vulgaris L.), lima bean (Phaseolus limensis Macf.), broad bean (Vicia faba L.), garden pea (Pisum sativum L.), peanut (Arachis hypogaea L.), alfalfa (Medicago sativa L.), beet (Beta vulgaris L.), garden lettuce (Lactuca sativa L.), rapeseed (Brassica rapa L. and B. napus L.), cole crops such as cabbage, cauliflower and broccoli (Brassica oleracea L.), turnip (Brassica rapa L.), leaf (oriental) mustard (Brassica juncea Coss.), black mustard (Brassica nigra Koch), tomato (Lycopersicon esculentum Mill.), potato (Solanum tuberosum L.), pepper (Capsicum frutescens L.), eggplant (Solanum melongena L.), tobacco (Nicotiana tabacum), cucumber (Cucumis sativus L.), muskmelon (Cucumis melo L.), watermelon (Citrullus vulgaris Schrad.), squash (Curcurbita pepo L., C. moschata Duchesne. and C. maxima Duchesne.), carrot (Daucus carota L.), zinnia (Zinnia elegans Jacq.), cosmos (e.g., Cosmos bipinnatus Cav.), chrysanthemum (Chrysanthemum spp.), sweet scabious (Scabiosa atropurpurea L.), snapdragon (Antirrhinum majus L.), gerbera (Gerbera jamesonii Bolus), babys-breath (Gypsophila paniculata L., G. repens L. and G. elegans Bieb.), statice (e.g., Limonium sinuatum Mill., L. sinense Kuntze.), blazing branched (e.g., Liatris spicata Willd., L. pycnostachya Michx., L. scariosa Willd.), lisianthus (e.g., Eustoma grandiflorum (Raf.) Shinn), yarrow (e.g., Achillea filipendulina Lam., A. millefolium L.), marigold (e.g., Tagetes patula L., T. erecta L.), pansy (e.g., Viola cornuta L., V. tricolor L.), impatiens (e.g., Impatiens balsamina L.), petunia (Petunia spp.), geranium (Geranium spp.) and coleus (e.g., Solenostemon scutellarioides (L.) Codd). Geotropic propagules also include rhizomes, tubers, bulbs or corms, or viable divisions thereof. Suitable rhizomes, tubers, bulbs and corms, or viable divisions thereof include those of potato (Solanum tuberosum L.), sweet potato (Ipomoea batatas L.), yam (Dioscorea cayenensis Lam. and D. rotundata Poir.), garden onion (e.g., Allium cepa L.), tulip (Tulipa spp.), gladiolus (Gladiolus spp.), lily (Lilium spp.), narcissus (Narcissus spp.), dahlia (e.g., Dahlia pinnata Cav.), iris (Iris germanica L. and other species), crocus (Crocus spp.), anemone (Anemone spp.), hyacinth (Hyacinth spp.), grape-hyacinth (Muscari spp.), freesia (e.g., Freesia refracta Klatt., F. armstrongii W. Wats), ornamental onion (Allium spp.), wood-sorrel (Oxalis spp.), squill (Scilla peruviana L. and other species), cyclamen (Cyclamen persicum Mill. and other species), glory-of-the-snow (Chionodoxa luciliae Boiss. and other species), striped squill (Puschkinia scilloides Adams), calla lily (Zantedeschia aethiopica Spreng., Z. elliottiana Engler and other species), gloxinia (Sinnigia speciosa Benth. & Hook.) and tuberous begonia (Begonia tuberhybrida Voss.). The above recited cereal, vegetable, ornamental (including flower) and fruit crops are illustrative, and should not be considered limiting in any way.

The present disclosure also relates to a kit comprising a first component and a second component. The first component comprises a coating composition wherein the coating composition comprises or consists essentially of;

a) at least one film forming binder,

b) at least one filler, and

c) an aqueous carrier.

The mean particle size of the filler is in the range of from 5 nanometers to 10 micrometers, the filler concentration is in the range of from 20 percent to 95 percent, wherein the percentage is based on the total volume of the dry coating composition and a layer of the coating composition has a water permeability as measured by the disclosed variant of ASTM 1653-03 of at least 75 milligrams/25 square centimeters/hour. The second component comprises a pesticide. Any of the previously described additives can be a part of the first or second components or both or they can be packaged separately as an additional component.

The two components of the kit can be mixed in to provide the propagule coating composition, wherein the propagule coating composition has a water permeability in the range of not less than 75 milligrams/25 square centimeters/hour. The ratio of mixing the first component with the second component can vary in order to provide the desired amount of pesticide in the propagule coating composition. In some embodiments, the mixing ratio of the first component to the second component can be in the range of from 1:10 to 100:1 wherein the mixing ratio is based on the volume of each component.

Each of the film forming binder, the filler, the aqueous carrier and the pesticide are the same as those previously described. The kit makes it convenient for the user to use the desired pesticide based on the environmental pressure at the time the propagule is to be planted in a growing media. For example, if insect pressure is expected to be relatively high, then an insecticide targeting the insect can be used as the second component. If the growing season is expected to be wet, then a fungicide may be used as the second component. In some embodiments, the kit may be supplied with multiple second components, each second component comprising a different pesticide, for example one of the second components can be an insecticide, while another of the second components can be a fungicide.

The components are typically packaged in separate containers. The containers can be metal, plastic, glass or a combination thereof. The containers can also be marked with volume amounts so as to assist in dispensing the proper amounts. Containers are well known in the art and any of the known containers can be used.

### Examples

Unless otherwise noted, all ingredients are available from the Sigma Aldrich Company, St. Louis, Mo.

RYNAXYPYR® insecticide, CYAZYPYR® insecticide, DERMACOR® seed coatings containing RYNAXYPYR® insecticide, ELVANOL® 50-42, ELVANOL® 51-04 and ELVANOL® 70-06 polyvinyl alcohols are available from E.I. du Pont de Nemours and Company, Wilmington, Del.

INKAID® White Matte Precoat is available from Ontario Specialty Coatings

### Watertown, N.Y.

LUDOX® AS-40 and AM silica dispersions are available from W. R. Grace and Company, Columbia, Md.

Color Coat Red Colorant is available from Becker Underwood, Research Triangle Park, N.C.

Aerosol OT-B wetting agent is available from Cytec Industries Inc., West Patterson, N.J.

Valspar® White Ceiling Paint 1426 is available from the Valspar Corporation, Minneapolis, Minn.

ROVACE® 9100AF polyvinyl acetate latex and DOWEX® Marathon MSC ion exchange resin are available from the Dow Chemical Company, Midland, Mich.

Measurement of Water Permeability

Measurement of the water permeability of a layer of the coating composition is determined using a variant of ASTM D1653-03 water flux method and requires a high humidity environment. The high humidity environment is provided by a Caron 6010 Environment chamber (available from Caron Products and Services, Inc., Marietta, Ohio) with the temperature set to 35° C. and the humidity set to 70 percent relative humidity (RH).

A layer of the coating composition was drawn down onto Leneta chart paper (Gardner Co. Leneta Plain White Chart Paper type NWK, available from the Paul Gardner Co., Pompano Beach, Fla.) using a #90 wire wound rod (Gardner Co. STD 16″OA, ½″ Dia #90 rod). The applied layer of coating composition on the Leneta chart paper was allowed to dry in an oven at 30° C. with slight nitrogen purge. For each example provided, the dry film thicknesses were typically between 38 and 64 micrometers.

Water permeability was measured using 25 square centimeter Perm cups available from Paul Gardner Company. The cups were charged with 10 grams of DRIERITE© desiccant (available from the W.A. Hammond Drierite Co. Ltd., Xenia, Ohio) and a disc of the coating on the Leneta chart paper was mounted on top. The cup was weighed and then put into the Caron 6010 Environment chamber with the temperature set to 35° C. and 70 percent relative humidity. The cup was removed for weighing every hour. The weight gain was plotted as a function of time and the slope of the line gives the water permeability of the film, in units of milligrams/25 square centimeters/hour. Each coating was tested two times and as long as the water permeability of the two trials were within 5 percent of each other, the results were considered to be reliable and the average of the two tests is reported. Using this procedure, the flux seen with the Leneta chart paper alone in any given experimental run (without any of the coating composition applied) is about 117 to 154 milligrams/25 square centimeters/hour, The water permeability observed when a layer of the coating composition is applied to the Leneta chart paper substrate (when measured according to the method described herein) cannot exceed the water permeability observed with the chart paper alone. Therefore, the maximum water flux measurable using this method is about 154 mg/25 cm²/hr.

In the following examples corn seeds, cultivar P4082W, available from Pioneer, Johnston, Iowa, were coated with the coating compositions using a bowl treater. The treated seeds were planted in 12.7 centimeter square pots filled with sterile Matapeake soil. 4 seeds were planted per pot at a depth of between 2.5 and 3.8 centimeters. The soil was saturated with water and the pots were held in a temperature and humidity controlled growth chamber. After 8 days, the aerial portion of the plants were clipped at the top of the coleoptile and collected in 20 milliliter scintillation vials. Each sample was processed by grinding the sample with steel balls in acetonitrile. The acetonitrile was filtered and analyzed by liquid chromatography/mass spec (LC/MS) to determine the content of chlorantraniliprole in each seedling.

Experiment #1

VALSPAR® Ceiling white paint #1426 is a paint specially formulated for use on ceilings. A dry sample of the VALSPAR® Ceiling white paint was analyzed and found to have a filler and void content of about 77 percent by weight. To each of these coating agents was added an amount of DERMACOR® 625FS in order to provide chlorantraniliprole insecticide in various amounts. Corn seeds were then coated with a layer of the coating composition. After the layer of coating composition had dried, the corn seeds were planted and tested for pesticide uptake according to the procedure given above. Table 1 shows the relevant data. VALSPAR® ceiling white paint has a water flux of 118 mg/25 cm²/hr without the addition of the pesticide.

TABLE 1

| | | | | Pesticide | Number |
|---|---|---|---|---|---|
| | Amount of | | Water Flux, with | mean | of plants |
| Coating | coating/ | chlorantraniliprole/ | pesticide | uptake | in |
| Treatment | seed | seed (μg) | (mg/25 cm²/hr) | (μg) | sample |
| 1 | 600 μg | 500 | 119 | 0.041 | 45 |
| | VALSPAR ® | | | | |
| 2 | 600 μg | 250 | 117 | 0.040 | 45 |
| | VALSPAR ® | | | | |
| 3 | 600 μg | 50 | 120 | 0.023 | 38 |
| | VALSPAR ® | | | | |

The results in Table 1 show that the uptake of the pesticide between Coatings 1, 2 and 3 are relatively equivalent even though the amount of pesticide in coatings 2 and 3 is one-half and one-tenth that of the amount in coating 1

Experiment #2

Preparation of Coatings 4 and 5.

Solutions of 10% ELVANOL® 50-42 polyvinyl alcohol in water and LUDOX® AS-40 silica as the filler were added to a suitable mixing vessel and stirred. The amount of each of the ingredients is shown in Table 2. DERMACOR® 625FS was also added to each of these mixtures to provide the desired amount of RYNAXYPYR® insecticide in the coatings.

TABLE 2

| | | | Filler |
|---|---|---|---|
| Coating | ELVANOL ® (grams) | LUDOX ® (grams) | Concentration |
| 4 | 11 | 20 | 81 |
| 5 | 11 | 10 | 68 |

Preparation of Coating 6

Coating 6 was prepared by mixing a sufficient amount of DERMACOR® 625FS with INKAID® white matte precoat. The INKAID® white matte precoat was analyzed and found to have a filler and void concentration of about 56 weight percent.

Each of coatings 4, 5, 6 and were then applied to corn seeds according to TABLE 3 and tested for pesticide uptake according to the procedure given above. The water permeability is given with the units of mg/25 cm²/hr.

TABLE 3

| | Amount | | Water | Water | Pesticide | |
|---|---|---|---|---|---|---|
| | of | | permeability | permeability | mean | Number |
| | coating/ | chlorantraniliprole/ | (w/o | (with | uptake | of plants |
| Coating | seed | seed | pesticide) | pesticide) | (μg) | in sample |
| 4 | 600 μg | 250 μg | 114 | 114 | 0.044 | 45 |
| 5 | 600 μg | 250 μg | 90 | 111 | 0.057 | 42 |
| 6 | 600 μg | 250 μg | 112 | 125 | 0.048 | 39 |

Statistical analysis (two sample t-test) of the data of Table 3 shows that the amounts of chlorantraniliprole insecticide found in plants grown with the coatings 4, 5, 6 shows no statistically significant differences in the pesticide uptake amounts.

Experiment #3

Preparation of Stock Coating

146 g of a 10% solution of ELVANOL® 50-42 polyvinyl alcohol was mixed with 350 g of LUDOX® AS-40 silica as the filler and stirred for an hour. This stock coating was designated 50-42/silica and used in the experiment below.

146 g of a 10% solution of ELVANOL® 51-04 polyvinyl alcohol was mixed with 350 g of LUDOX® AS-40 silica as the filler and stirred for an hour. This stock coating was designated 51-04/silica and used in the experiment below.

Coatings were prepared according to Table 4. The polymer indicated was mixed with the necessary amounts of DERMACOR 625FS, a fungicide, Color Coat Red colorant and Aerosol OTB wetting agent. The coatings were then applied to cultivar 93M11 soy seeds according to Table 4.

TABLE 4

| | | Film | | | | |
|---|---|---|---|---|---|---|
| | Film | forming | | | Color | Aerosol |
| | Forming | binder | chlorantraniliprole | Fungicide | Coat Red | OT-B |
| Coating | Binder | (μg/seed) | (μg/seed) | (μg/seed) | (μg/seed) | (μg/seed) |
| 7 | 50-42/ | 377 | 50 | 0 | 51 | 1.9 |
| | silica | | | | | |
| 8 | 50-42/ | 377 | 50 | 20 | 51 | 1.9 |
| | silica | | | | | |
| 9 | 51-04/ | 377 | 50 | 0 | 51 | 1.9 |
| | silica | | | | | |
| 10 | 51-04/ | 377 | 50 | 20 | 51 | 1.9 |
| | silica | | | | | |
| 11 | 51-04/ | 1131 | 50 | 20 | 51 | 5.6 |
| | silica | | | | | |

The treated soybean seeds were planted in 12.7 centimeter square pots filled with sterile Matapeake soil. 4 seeds were planted per pot at a depth of between 2.5 and 3.8 centimeters. The soil was saturated with water and the pots were held in a temperature and humidity controlled growth chamber. The plants were grown to the first trifoliate stage. The first trifoliate was harvested and collected in 20 milliliter scintillation vials. Each sample was processed by grinding the sample with steel balls in acetonitrile. The acetonitrile was filtered and analyzed by liquid chromatography/mass spec (LC/MS) to determine the content of chlorantraniliprole insecticide in each seedling.

The water permeability of the coatings and the uptake of chlorantraniliprole into the first trifoliates is shown in Table 5. The water fluxes of the coatings without the addition of the pesticide is reported in the table as is the water flux for the coating compositions of coatings 7 through 11 with the addition of the pesticide.

TABLE 5

| | Water | | | | |
|---|---|---|---|---|---|
| | permeability, | | Water Flux, with | chlorantraniliprole | Number |
| | w/o pesticide | Filler | pesticide | mean uptake | of plants |
| Coating | (mg/25 cm²/hr) | Concentration | (mg/25 cm²/hr) | (nanograms/gram) | in sample |
| 7 | 135 | 85 | 124 | 68.54 | 40 |
| 8 | 135 | 85 | 125 | 68.55 | 43 |
| 9 | 139 | 85 | 116 | 54.72 | 37 |
| 10 | 139 | 85 | 116 | 51.88 | 43 |
| 11 | 139 | 85 | 124 | 60.8 | 40 |

Experiment #4

Preparation of Stock Coating

146 grams of a 10% solution of ELVANOL® 50-42 polyvinyl alcohol was mixed with 350 grams of LUDOX® AS-40 silica as the filler and stirred for one hour, then used as is.

Coatings were prepared according to Table 6. The polymer indicated was mixed with the necessary amount of DERMACOR® 625FS. The coatings were then applied to cultivar 93M11 soybean seeds.

TABLE 6

| | | | Amount of |
|---|---|---|---|
| | Film forming | RYNAXYPYR ® | binder/seed |
| Coating | binder | (μg/seed) | (μg/seed) |
| 13 | Stock Coating | 50 | 377 |
| 14 | Stock Coating | 25 | 1131 |
| 15 | Stock Coating | 50 | 1131 |

The treated soybean seeds were planted in 12.7 centimeter square pots filled with sterile Matapeake soil. 4 seeds were planted per pot at a depth of between 2.5 and 3.8 centimeters. The soil was saturated with water and the pots were held in a temperature and humidity controlled growth chamber. The plants were grown to the third trifoliate stage. The first trifoliate was harvested and collected in 20 milliliter scintillation vials. Each sample was processed by grinding the sample with steel balls in acetonitrile. The acetonitrile was filtered and analyzed by liquid chromatography/mass spec (LC/MS) to determine the content of chlorantraniliprole insecticide in each seedling.

The water fluxes of the coatings and the uptake of chlorantraniliprole into the first trifoliates is shown in Table 7. The water fluxes of the coatings without the addition of the pesticide is reported in the table as is the water flux for the coating compositions of coatings 13 through 15 with the addition of the pesticide.

TABLE 7

| | | Filler | | Pesticide | |
|---|---|---|---|---|---|
| | Water | Con- | | mean | Number |
| | Flux | centration | Water | uptake | of plants |
| | (w/o | (w/o | flux (with | (nanograms/ | in |
| Coating | pesticide) | pesticide) | pesticide) | gram) | sample |
| 13 | 117 | 85 | 138 | 153.6 | 41 |
| 14 | 117 | 85 | 144 | 73.79 | 44 |
| 15 | 117 | 85 | 145 | 113.07 | 41 |

Preparation of Low Flux Coating

10 grams of ROVACE® 9100AF polyvinyl acetate latex was mixed with 2 grams of Color Coat red pigment and the mixture was stirred for 10 minutes.

Desalting of LUDOX® AM silica

900 grams of LUDOX® AM was stirred with 30 grams of DOWEX® Marathon MSC (Hydrogen Form) ion exchange resin (available from Dow Chemical Company) at room temperature for twenty minutes. The pH of the dispersion dropped from 8.75 to 2.88 over this period of time. The dispersion was filtered through a coarse filter to remove the Dowex resin and used in the preparation below.

Preparation of Stock Coating

275 grams of a 10% solution of ELVANOL® 70-06 was mixed with 700 grams of desalted LUDOX® AM and 5 grams of Croda Multiwet MO-70R-LQ-(AP) wetting agent and mixed for one hour with a mechanical stirrer.

Preparation of Coatings 16-23

Coatings were prepared by mixing the ingredients in Table 8.

TABLE 8

| | | | | | Amount |
|---|---|---|---|---|---|
| | | | | | of |
| | | | | | binder/ |
| | Film | | | Color | seed |
| | Forming | Rynaxypyr ® | Cyazypyr ® | Coat Red | (ug/ |
| Coating | Binder | (ug/seed) | (ug/seed) | (ug/seed) | seed) |
| 16 | Stock | 125 | | 64 | 600 |
| | Coating | | | | |
| 17 | Stock | 250 | | 64 | 600 |
| | Coating | | | | |
| 18 | None | 250 | | | |
| 19 | Low Flux | 250 | | | 600 |
| | Coating | | | | |
| 20 | Stock | | 125 | 64 | 600 |
| | Coating | | | | |
| 21 | Stock | | 250 | 64 | 600 |
| | Coating | | | | |
| 22 | None | | 250 | | |
| 23 | Low Flux | | 250 | | 600 |
| | Coating | | | | |

The indicated coatings were applied to PIONEER® Hybrid corn seed using a Hege bowl treater. The treated seeds were planted in 12.7 centimeter square pots filled with sterile Matapeake soil. 4 seeds were planted per pot at a depth of between 2.5 and 3.8 centimeters. The soil was saturated with water and the pots were held in a temperature and humidity controlled growth chamber. After 8 days, the aerial portion of the plants were clipped at the top of the coleoptile and collected in 20 milliliter scintillation vials. Each sample was processed by grinding the sample with steel balls in acetonitrile. The acetonitrile was filtered and analyzed by liquid chromatography/mass spec (LC/MS) to determine the content of chlorantraniliprole or cyantraniliprole in each seedling. The results are shown in Table 9.

TABLE 9

| | Film | | Pesticide | Number of |
|---|---|---|---|---|
| | Forming | Water Flux | Uptake | Plants in |
| Coating | Binder | (mg/25 cm²/hr) | (ug) | sample |
| 16 | Stock | 147.6 | 0.118 | 47 |
| | Coating | | | |
| 17 | Stock | 137.4 | 0.118 | 48 |
| | Coating | | | |
| 18 | None | n/a | 0.100 | 48 |
| 19 | Low Flux | 29.2 | 0.059 | 46 |
| | Coating | | | |
| 20 | Stock | 143.2 | 0.622 | 46 |
| | Coating | | | |
| 21 | Stock | 135.2 | 0.574 | 46 |
| | Coating | | | |
| 22 | None | n/a | 0.546 | 48 |
| 23 | Low Flux | 29.8 | 0.449 | 48 |
| | Coating | | | |

1. A method comprising the steps of;
i) providing a coating composition wherein the coating composition comprises;
a) at least one film forming binder,
b) at least one filler, and
d) an aqueous carrier,
wherein the mean particle size of the filler is in the range of from 5 nanometers to 10 micrometers, the filler concentration is in the range of from 20 to 95 percent by volume, based on the total volume of the dry coating composition and the coating composition has a water permeability of at least 75 milligrams/25 square centimeters/hour, and
ii) adding a pesticide to the coating composition to form a propagule coating composition, wherein the propagule coating composition has a water permeability that is not less than 75 milligrams/25 square centimeters/hour; and
iii) applying a layer of the coating composition, to which a pesticide has been added, onto at least a portion of a propagule.

2. The method of claim 1 wherein the method further comprises the step of iv) removing at least a portion of the aqueous carrier from the applied layer of propagule coating composition.

3. (canceled)

4. The method of claim 1 wherein the water permeability of the coating composition is at least 80 milligrams/25 cm²/hour.

5. (canceled)

6. The method of claim 1 wherein the water permeability of the coating composition is at least 100 milligrams/25 cm²/hour.

7. The method of claim 1 wherein the at least one filler is substantially spherical and has a water solubility at 20° C. of less than 100 milligrams per liter of water.

8. The method of claim 1 wherein the at least one filler is silica, colloidal silica, fumed silica, silica gel, iron oxide, calcium carbonate, calcium sulfate, magnesium carbonate, barium carbonate, barium sulfate, zinc oxide, talc, kaolin, titanium dioxide, lithopone, aluminum oxide, illite, smectite, montmorillonite, quartz, pumice, zeolites, diatomaceous earth, perlite, dolomite, alumina modified colloidal silica, alumina modified fumed silica or a combination thereof.

9. The method of claim 1 wherein the at least one film forming binder is a water soluble or water dispersible film forming binder.

10. (canceled)

11. (canceled)

12. The method of claim 1 wherein the pesticide comprises an anthranilic diamide of Formula 1, N-oxides, or salts thereof; 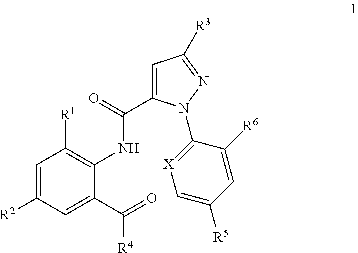
wherein
X is N, CF, CCl, CBr or Cl;
R¹ is CH₃, Cl, Br or F;
R² is H, F, Cl, Br or —CN;
R³ is F, Cl, Br, C1 to C4 haloalkyl, C1 to C4 haloalkoxy or Q;
R⁴ is NR⁷R⁸, N═S(CH₃)₂, N═S(CH₂CH₃)₂, N═S(CH(CH₃)₂)₂;
R⁵ is H, F, Cl or Br;
R⁶ is H, F, Cl or Br;
each R⁷ and R⁸ is independently H, C1 to C6 alkyl, C3 to C6 cycloalkyl, cyclopropylmethyl or 1-cyclopropylethyl; and
Q is a —CH₂-tetrazole radical.

13. The method of claim 1 wherein the pesticide comprises an anthranilic diamide of Formula 2, N-oxides, or salts thereof; 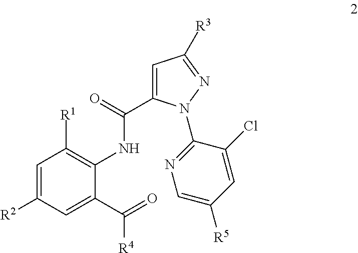
wherein
R¹ is CH₃, Cl, Br or F;
R² is H, F, Cl, Br or —CN;
R³ is F, Cl, Br, C1 to C4 haloalkyl, C1 to C4 haloalkoxy or Q;
R⁴ is NHCH₃, NHCH₂CH₃, NHCH(CH₃)₂, NHC(CH₃)₃, NHCH₂(cyclopropyl), NHCH (cyclopropyl)CH₃, N═S(CH₃)₂, N═S(CH₂CH₃)₂ or N═S(CH(CH₃)₂)₂;
R⁵ is H, F, Cl or Br.

14. (canceled)

15. The method of claim 1 wherein a plant grown from the coated propagule exhibits an increased uptake of the pesticide when compared to a second plant grown from a propagule coated with a second coating composition that is identical to the first coating composition but for the filler concentration of the second coating composition, which, in the second coating composition has a lower filler concentration resulting in a water permeability of less than 75 milligrams/25 square centimeters/hour.

16. The method of claim 1 wherein the pesticide is chlorantraniliprole or cyantraniliprole.

17. (canceled)

18. (canceled)

19. (canceled)

20. (canceled)

21. (canceled)

22. A propagule coating composition comprising coating composition and a pesticide, wherein the coating composition comprises;
a) at least one film forming binder;
b) at least one filler; and
c) an aqueous carrier;
wherein the mean particle size of the filler is in the range of from 5 nanometers to 10 micrometers, the filler concentration of the coating composition is in the range of from 20 percent to 95 percent by volume, based on the total volume of the dry coating composition, the coating composition has a water permeability at least 75 milligrams/25 square centimeters/hour; and wherein the propagule coating composition has a water permeability that is not less than 75 milligrams/25 square centimeters/hour.

23. The propagule coating composition of claim 22 wherein the water permeability of the propagule coating composition is at least 80 milligrams/25 cm²/hour.

24. (canceled)

25. The propagule coating composition of claim 22 wherein the filler concentration is greater than or equal to 40 percent by volume.

26. The propagule coating composition of claim 22 wherein the at least one filler is substantially spherical and has a water solubility at 20° C. of less than 100 milligrams per liter of water.

27. (canceled)

28. The propagule coating composition of claim 22 wherein the at least one film forming binder is a water soluble or water dispersible film forming binder.

29. (canceled)

30. The propagule coating composition of claim 22 wherein the pesticide comprises an anthranilic diamide of Formula 1, N-oxides, or salts thereof; 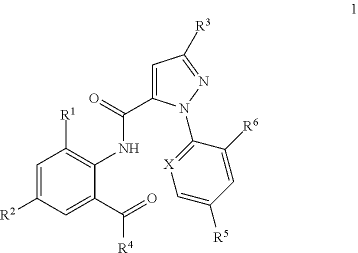
wherein
X is N, CF, CCl, CBr or Cl;
R¹ is CH₃, Cl, Br or F;
R² is H, F, Cl, Br or —CN;
R³ is F, Cl, Br, C1 to C4 haloalkyl, C1 to C4 haloalkoxy or Q;
R⁴ is NR⁷R⁸, N═S(CH₃)₂, N═S(CH₂CH₃)₂, N═S(CH(CH₃)₂)₂;
R⁵ is H, F, Cl or Br;
R⁶ is H, F, Cl or Br;
each R⁷ and R⁸ is independently H, C1 to C6 alkyl, C3 to C6 cycloalkyl, cyclopropylmethyl or 1-cyclopropylethyl; and
Q is a —CH₂-tetrazole radical.

31. The propagule coating composition of claim 22 wherein the at least one pesticide comprises an anthranilic diamide of Formula 2, N-oxides, or salts thereof; 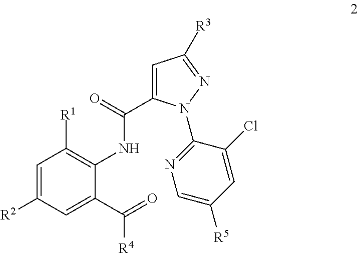
wherein
R¹ is CH₃, Cl, Br or F;
R² is H, F, Cl, Br or —CN;
R³ is F, Cl, Br, C1 to C4 haloalkyl, C1 to C4 haloalkoxy or Q;
R⁴ is NHCH₃, NHCH₂CH₃, NHCH(CH₃)₂, NHC(CH₃)₃, NHCH₂(cyclopropyl), NHCH (cyclopropyl)CH₃, N═S(CH₃)₂, N═S(CH₂CH₃)₂ or N═S(CH(CH₃)₂)₂;
R⁵ is H, F, Cl or Br.

32. (canceled)

33. The propagule coating composition of claim 22 wherein the pesticide is chlorantraniliprole or cyantraniliprole.

34. The propagule coating composition of claim 22 wherein the water solubility at 20° C. of the pesticide is in the range of from 0.001 milligrams per liter to 1000 milligrams per liter.

35. (canceled)

36. (canceled)

37. The propagule coating composition of claim 22 wherein the film forming binder is polyvinyl alcohol and the at least one filler is colloidal silica, fumed silica or an alumina modified colloidal or fumed silica.

38. (canceled)

39. A propagule coated with a layer of the propagule coating composition of, wherein the composition comprises;
a) at least one film forming binder;
b) at least one filler; and
c) an aqueous carrier;
wherein the mean particle size of the filler is in the range of from 5 nanometers to 10 micrometers, the filler concentration of the coating composition is in the range of from 20 percent to 95 percent by volume, based on the total volume of the dry coating composition, the coating composition has a water permeability at least 75 milligrams/25 square centimeters/hour; and wherein the propagule coating composition has a water permeability that is not less than 75 milligrams/25 square centimeters/hour.

40. (canceled)

41. (canceled)

42. (canceled)

43. (canceled)

44. (canceled)

45. (canceled)

46. (canceled)

47. (canceled)

48. (canceled)
